(19) United States
(12) Patent Application Publication
(10) Pub. No.: US 2022/0085866 A1
(43) Pub. Date: Mar. 17, 2022

(54) A DIVERSITY SCATTERING DEVICE AND METHOD FOR USING THE SAME

(71) Applicant: StealthCase Oy, Tampere (FI)

(72) Inventor: Juha LILJA, Tampere (FI)

(73) Assignee: StealthCase Oy, Tampere (FI)

(21) Appl. No.: 17/419,349

(22) PCT Filed: Dec. 19, 2019
(86) PCT No.: PCT/FI2019/050908

§ 371 Date: Jun. 29, 2021

(30) Foreign Application Priority Data
Dec. 31, 2018 (FI) 20186142

(51) Int. Cl. H04B 7/145; H01Q 1/24; H01Q 1/38; H01Q 21/06; H04B 7/155; H04B 7/26

(52) U.S. Cl. CPC H04B 7/145; H01Q 1/246; H04B 7/2606; H01Q 21/061; H04B 7/1555; H01Q 1/38

(57) ABSTRACT

A device and method for repeating wireless electromagnetic signals from a first side of a space divider to a second side of the space divider. The device provides discriminated communication channels at a first frequency range between the two spaces. The device includes a dual polarized repeater including a dielectric member, and conductive members as a group of radiators. The dual polarized repeater is installed into a discontinuity region of the space divider and provides an increment of a bistatic radar cross section through the discontinuity region for a first and second incident signals. A part of the first incident signal is scattered as a first beam by the device, and a part of the second incident signal is scattered as a second beam on the second side of the space divider. The dual polarized repeater provides cross polarization discrimination for the first and second incident signals.

### TECHNICAL FIELD

The aspects of the disclosed embodiments relate to a scattering device for enhancing multiple-input-multiple-output (MIMO) and/or diversity characteristics of at least two wireless communication channels arranged between two divided spaces.

More specifically, the aspects of the disclosed embodiments relate to a device for repeating wireless electromagnetic signals from a first side of a space divider to a second side of a space divider, the device is adapted to provide at least two discriminated communication channels at a first frequency range between the two spaces separated by the space divider.

The space divider may be a construction supply such as an energy efficient window, a part of a facade system, a wall element, a metal coated insulation element, or the like. The space divider may also be a part of a cargo container, a reefer, a housing container, a railway carriage, a ship cabin, a modular space, or similar unit which may cause shadow areas for the wireless electromagnetic signals due to the electromagnetic signal attenuation caused by the space divider.

The aspects of the disclosed embodiments also relate to a method of providing an enhanced MIMO or diversity communication capabilities between divided spaces.

### BACKGROUND

Aims of the construction industry to build passive and zero energy buildings have led to multiple situations in which wireless communication networks are suffering from poor indoor coverage and even in dead spaces without any reception capabilities inside such buildings.

Energy efficient windows, such as Low-E (low-energy) windows or glasses are one significant reason for large signal attenuation, but also concrete walls and walls comprising aluminium coated insulation panels are causing significant signal attenuation.

Mobile phones, tablets, Internet of Things (IoT) sensors, and many other communication devices rely on wireless signals, and increased signal attenuation may reduce the usability, reliability and data rates of such devices.

Commonly used communication systems such as 2G, 3G, 4G, 5G and beyond are all dependent on a high quality signal, which in other words means a signal having a decent signal-to-noise ratio (SNR). Moreover, both the performance and maximum range of systems based on WLAN (Wireless Local Area Network), WiGig (Wireless Gigabit Alliance), RFID (Radio Frequency Identification), LoRa (Long Range), Sigfox, NB-IoT (Narrow Band Internet-of-Things), or the like, are all bound by the same physics that affect the propagation and attenuation of electromagnetic waves. Increased attenuation decreases communication distances due to the limitations set by the noise floor of the receiving radio devices. Furthermore, decreased strength of a received signal reduces the SNR, which is generally known to be one of the key parameters affecting the capacity of wireless communication channels.

Multi path propagation can be utilized in advantage of the communication links. Diversity reception methods are well established, and methods to provide diversity gain are a common part of today's radio receivers. Another fundamental characteristic in modern wireless networks is using multiple-input-multiple-output (MIMO) channels. Both MIMO and diversity techniques can benefit from multipath propagation due to the multiple uncorrelated communication channels through the communication space, or in practice, multiple channels having low cross-correlation.

Rich scattering environment may be provided by having signals arriving from multiple directions or in different polarizations. Diversity reception methods are known to be an effective approach to recover parts of the signal at the edge of a communication link, or to increase the reliability of a link by reducing the effects of sudden signal drops. Similarly, MIMO techniques can be utilized in advantage of the channel capacity, when channels of low cross-correlation may be used to transmit independent parts of the transmitted information at a given sequence of time.

### SUMMARY

It is an aim of the aspects of the disclosed embodiments to improve the state of the art and to pro-vide a device with enhanced properties for repeating electromagnetic MIMO and/or diversity signals between separated spaces by providing at least two discriminated communication channels at a first frequency range through a space divider, where said channel separation is provided at least with a dual polarized repeater.

In a preferred embodiment of the present disclosure, the device is adapted to be installed into a sub-wavelength passage in the space divider, where said sub-wavelength passage is provided by a discontinuity region having at least a first dimension smaller than a wavelength at a first frequency range.

The aspects of the disclosed embodiments may provide improved signal-to-noise ratios for wireless radio appliances operating inside buildings or in other space shadowed at least by the space divider. This aspect of the disclosed embodiments promotes increased data rates and improved network reliability and/or communication range compared to situations without using the device of the present disclosure. In accordance with an embodiment, the device comprises at least a dual polarized repeater.

The space divider may be a construction supply such as an energy efficient window, a part of a facade system, a wall element, a metal coated insulation element, or the like. The space divider may also be a part of a cargo container, a reefer, a housing container, a railway carriage, a ship cabin, a modular space, or similar unit which may cause shadow areas for the wireless electromagnetic signals due to the electromagnetic signal attenuation caused by the space divider. The space divider attenuates electromagnetic signals at a first frequency range at least by 6 dB. Typical attenuation levels may range from 10 dB up to 50 dB, but even higher attenuations may be possible.

The aspects of the disclosed embodiments relates to a device for enhancing MIMO and/or diversity properties of wireless communication channels between divided spaces by providing at least two discriminated communication channels through the space divider.

The device of the present disclosure provides at least two discriminated communication channels through the space divider at a first frequency range. Said at least two isolated communications channels may be generated by providing separate signal propagation channels that are uncorrelated or have a low cross correlation.

The device according to the present disclosure is primarily characterised by having three aspects while repeating the wireless signals. In order to provide the device according to the present disclosure, i.e. a repeater having at least two separated diversity and/or MIMO channels with low cross-correlation through a space divider, a device with three signal separation aspects may be needed. First, the low- or uncorrelated signal components are received by the device from a first side of the space divider while preserving the low correlation of said signal components. Second, said separated signal components are bridged from one side of the space divider to another side of the space divider by the device while preserving the low correlation of said signal components. Third, the separated signal components are re-radiated by the device to the second side of the construction supply while preserving said signal separation.

In contrast to the device of the present disclosure, there might be a repeater comprising an antenna capable of receiving and emitting signals at crossing polarizations without the capability to provide the enhanced MIMO properties as presented for the device of the present disclosure. Without all the three presented signal separation aspects, such repeating device might even deteriorate the quality of a communication link by summing the signals from otherwise separately propagating MIMO channels. Such unintended summing or depolarization may be translated into an increase in channel correlation between otherwise separated diversity of MIMO channels. This drawback may reduce the capacity of a wireless communication link.

It is an aim of the aspects of the disclosed embodiments to provide a device for establishing at least two separated MIMO and/or diversity channels from one side of a space divider to another side of the space divider, where said channel separation is provided at least with a dual polarized repeater which is arranged to first receive and separate signals in two crossing polarizations from a first side of the space divider at a first frequency range, secondly coupling said separated signals from the first side of the space divider to a second side of the space divider while maintaining the signal separation, and thirdly to radiate said signals separately to the second side of the space divider while maintaining the signal separation.

It is an aim of the aspects of the disclosed embodiments to provide a device with enhanced capabilities of receiving signals of two crossing polarizations at a first frequency range through a sub-wavelength passage in an arrangement, where the discrimination of said two crossing polarization components is maintained.

In an embodiment of the present disclosure, said sub-wavelength passage comprises a discontinuity region in the space divider, where said discontinuity region has at least a first dimension smaller than a wavelength at the first frequency range.

It is an aim of the aspects of the disclosed embodiments to provide a device for repeating wireless electromagnetic signals from a first side of a space divider to a second side of a space divider, the device is adapted to provide at least two discriminated communication channels at a first frequency range between the two spaces separated by the space divider.

The device according to a first aspect of the present disclosure is characterized in that the device comprises a dual polarized repeater, where said dual polarized repeater comprises a set of conductive members arranged as a group of radiators, where said group of radiators further comprises a first set of resonators and a second set of resonators, where the first set of resonators is arranged to receive and separate signals of a first and a second incident polarization components at the first frequency range from the first side of the space divider, where said first and second incident polarization components are crossing polarizations, and further where the second set of resonators is arranged to re-radiate said received and separated signals to the second side of the space divider in two crossing polarizations at the first frequency range, where said dual polarized repeater further comprises an arrangement for at least two isolated connections to couple said received and separated signals between said first and said second set of resonators, and a dielectric member acting as a substrate for any of the components of the dual polarized repeater.

The device according to a second aspect of the present disclosure is characterized in that the dual polarized repeater is adapted to be installed into a discontinuity region of the space divider to create said at least two discriminated communication channels by providing an increment of a bistatic radar cross section (RCS) through said discontinuity region for a signal received at said first incident polarization component and for a signal received at said second incident polarization component, and where said dual polarized repeater is adapted to provide cross polarization discrimination (XPD) for the signals received in said first and second incident polarization components in said two crossing polarizations radiated by said second set of resonators at the first frequency range.

The device according to a third aspect of the present disclosure is primarily characterized in that the device is arranged to re-radiate signals through the discontinuity region in two beams at the first frequency range, where said two beams are arranged to provide discrimination for the cross-polarized signal component in each of said two beams, where the corresponding co-polarized signal components in said two beams are crossing polarizations.

Some advantageous embodiments of the present disclosure are presented in the dependent claims.

One aspect of the present disclosure is that the device can be installed afterwards in already existing buildings or similar places where a space divider is attenuating wireless signals. Such retro-fitted device can bring significant benefits in, e.g., energy efficient buildings that have pronounced issues with wireless connectivity, and energy efficient windows have already been installed or at least partially installed. It may not be cost efficient to remove already installed window units and replace these with different kind of window units where attenuation is lower. In such cases, the device of the present disclosure may bring lots of benefits in terms of material cost and operational costs related to working times. Moreover, adding retro-fitted devices according to the present disclosure in the above cases may lower the need for afterwards installed distributed antenna system (DAS) inside the building. Such DAS systems with cablings and active repeaters may cost even tens of thousands of euros.

In an embodiment, the device of the present disclosure may be retrofitted in buildings and/or facades to enhance indoor connectivity. It is an aim of the aspects of the disclosed embodiments to enhance the MIMO and/or diversity channels through the attenuating obstacles of the building walls, facades, or parts of the aforementioned, including separate construction supplies. One benefit of the present disclosure is that it may enhance the performance of a fixed wireless access from external base stations to indoor peripherals. An important enabler for fixed wireless access, i.e. fixed wireless broadband is a reliable wireless connection. Modern wireless communication systems such as 4G/5G, and beyond, rely heavily on the use of MIMO channels. As an example, the frequency range of around 3.5 GHz is recognized as a potential candidate to enable fixed wireless broadband to compete with physical cablings. It is an aim of the present disclosure to provide a device that is capable of creating or enhancing the diversity and/or MIMO propagation channels through an attenuating space divider via a sub-wavelength passage.

In an embodiment, the device of the present disclosure is arranged as a pathway for a fixed wireless access signal. In such arrangement, the signal of separate multipath propagation channels may be redirected to indoor wireless terminals. In another embodiment, the device may be arranged to provide the signal of external base stations to a wireless access router, which is arranged to couple to the device of the present disclosure. It may be beneficial to arrange one or a plurality of the devices of the present disclosure to window units or in connection with walls to enable physically fixed connection nodes and/or pathways for the signals of massive MIMO base stations. In such arrangements it may be beneficial to optimize algorithms and weighting factors for the antenna arrays of the base stations and therefore to provide reliable wireless connections to indoors. When the connection points are not physically moving over time, the time and resources needed for radiation pattern deforming may be reduced.

One benefit of the present disclosure is that it may simplify the operation of modern base stations in which multi user MIMO (MU-MIMO) is used. In MU-MIMO, the connections between the base stations and indoor user terminals may be multiplexed using the same frequency, where the service for separate users may be provided through separate beams of the base station. When the building wall is heavily attenuating the wireless signal, and when the devices according to the present disclosure are provided in the walls of separate apartments, there emerges an optimal situation where the MU-MIMO beams of the base station for separate users are located at precisely fixed spots in the building wall. In an example having a multi-story building with concrete walls, the cells of separate users may be effectively separated utilizing the attenuation of the wall, and providing the connection through localized spots in the wall through the devices according to the present disclosure.

In another embodiment, the device of the present disclosure is arranged as a pathway for WLAN signals in the walls of ships or ship cabins.

In another embodiment, the device of the present disclosure is arranged as a pathway for RFID signals in the walls of shipping containers, reefers, or the like. In said embodiment, it is beneficial to provide signals of two crossing polarizations through the attenuating obstacles to avoid tag reading issues due to polarization mismatch. One or both of said polarizations may be arranged as a circular polarization.

In another embodiment, the two beams provided by the device may be arranged to cover substantially separated spherical sectors to enhance the probability of connecting to multiple base stations (dual/multi connectivity) or to utilize space diversity.

One aspect that distinguishes the present disclosure from prior art is that the device according to the present disclosure increases the bistatic radar cross section through the aperture when the device is applied. In an example, one may consider a large physical aperture arranged on a space divider, such as a building wall. Said physical aperture may act as a pathway to electromagnetic signals in different polarizations, and it may allow isolated diversity channels through said aperture, such as cross polarized signal components passing through the aperture. An effective aperture and therefore a gain may be defined for said physical aperture. It is known by a person skilled in the art that an effective aperture of an aperture antenna can never be larger than its physical aperture. Furthermore, the concept of a bistatic radar cross section may be applied to said aperture. When, e.g., an energy efficient window is inserted into said physical aperture, where said window is having a low emissivity coating with a frequency selective surface (FSS) applied to said coating, the low emissivity coating has always an electrical conductivity deviating from infinite conductivity. In practical low emissivity coatings, the surface resistance may be of the order of tens of ohms per square. Such resistive losses lower the transmission efficiency of the frequency selective surface for the electromagnetic signal, and as a result of this, the gain of the aperture is always lower than the directivity of the aperture. This concludes that applying a conductive layer having a frequency selective surface on a physical aperture always reduces the bistatic radar cross section through said aperture. This is very contradictory with the aspect of the device of the present disclosure, which increases the bistatic radar cross section when applied. Furthermore, the device of the present disclosure increases the bistatic radar cross section in two crossing polarizations in two isolated beams having cross polarization discrimination.

According to a first functionality of this present disclosure, the device may operate as a dual polarized passive repeater to create two isolated beams at a first frequency range, where the device is arranged to increase the bistatic radar cross section though a sub-wavelength aperture in two crossing polarizations.

In addition, the present disclosure has a secondary functionality, in which the device is utilized as a passage for a fixed wireless access signals.

### BRIEF DESCRIPTION OF THE DRAWINGS

In the following, the present disclosure will be described in more detail with reference to the appended drawings, in which

FIG. 1a shows an abstraction of a device of the present disclosure, in accordance with an embodiment;

FIG. 1b shows an abstraction of a first and second communication channels, in accordance with an embodiment;

FIG. 1c shows an abstraction of the electric fields of received and scattered signals at a first frequency range, in accordance with an embodiment, and the definition of cross polarization discrimination for said signals;

FIG. 2a shows an abstraction of the device in accordance with an embodiment;

FIG. 2b shows an example of the device in accordance with an embodiment;

FIGS. 3a-3f show examples of resonators, where resonant gaps are arranged within electrically non-conductive regions between edges of conductive members;

FIGS. 4a-4b i.present currents and electric fields of resonators, in an arrangement where the resonators are arranged as the first set of resonators to receive the first and second incident polarization components at the first frequency range;

FIGS. 4c-4d show examples of resonators that are arranged to operate at two crossing polarizations while maintaining the discrimination of the crossing polarization components;

FIGS. 5a-5b show an example of a retrofittable device;

FIGS. 6a-6b show an example of the device in connection with an energy efficient window unit;

FIG. 7 shows an example of the device in accordance with an embodiment; and

FIG. 8 shows an example of the first set of resonators 633, in accordance with an embodiment.

### DETAILED DESCRIPTION

Electromagnetic scattering is a process where an object receives electromagnetic energy from an incident electromagnetic signal and re-radiates at least a part of this received electromagnetic energy to a solid angle or a plurality of directions having separate solid angles. The incident electromagnetic signal comprises an oscillating electromagnetic wave, which may be characterized by its polarization and oscillation frequency. Polarization is defined by the electric field orientation of said signal in a given state, and it is well known how an electromagnetic signal may be linearly, elliptically, or circularly polarized.

It is known by anyone skilled in the art that the electromagnetic energy carried by a propagating electromagnetic signal may be characterized by the Poynting vector, i.e. the intensity vector, of the wave front, which describes the energy flux through a unit area per time unit. Energy flux may be denoted by watts per square meter (W/m2). In other words, it describes the power density over a given surface, or the intensity of the electromagnetic signal, thus giving the amount of energy that is flowing through a given surface area in a time unit.

Radar cross section (RCS) is used to describe how much a scattering object captures and re-radiates electromagnetic energy from an incident electromagnetic wave which is illuminating said scattering object. Radar cross section may also be denoted as scattering cross section, and the concept of RCS is well known by anyone skilled in the art. RCS of an object may be described by the received and re-radiated power. It may also be described by the received and re-radiated intensity of the electromagnetic signal. RCS is a function of the polarizations of both the incident and the scattered field, as well as the directions of both the incident and scattered waves. A commonly used concept of RCS is the monostatic case, in which the source of the incident wave and the observation of the scattered or reflected wave occur in the same direction. However, when the behavior of the device according to the present disclosure is of interest, the bistatic radar cross section is mainly observed. Bistatic radar cross section refers to a concept where the direction of the incident wave deviates from the direction of the scattered wave.

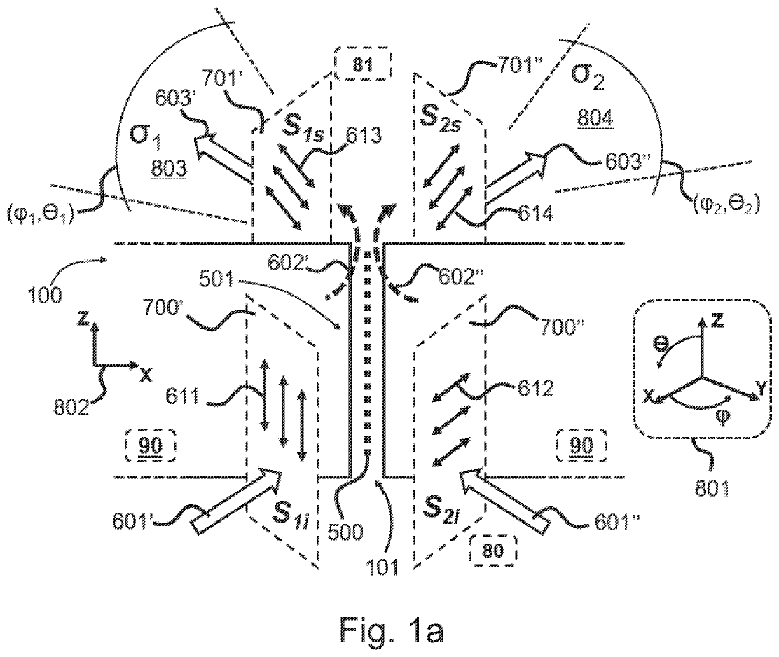

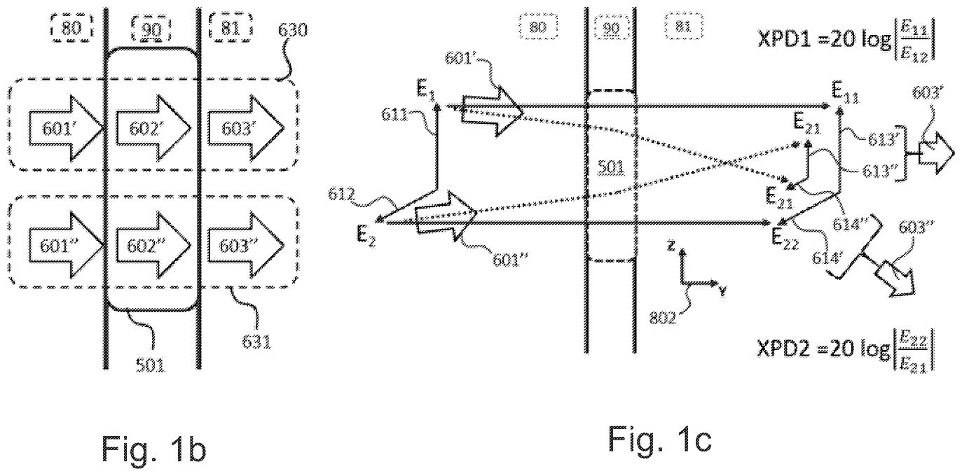

According to an embodiment, the device 501 (FIG. 1a) provides an increment of the bistatic radar cross section through the discontinuity region 101 in the space divider 90, characterized by that the direction of the incident signal 601 is defined on the first side 80 of the space divider 90, and the direction of the re-radiated signal 603 is defined on the second side 81 of the space divider 90.

According to an embodiment, the discontinuity region 101 comprises at least a first dimension smaller than a wavelength at the first frequency range.

It may be advantageous to use the intensity of the incident and scattered electromagnetic waves to describe the device of the present disclosure due to the fact that in an embodiment of the present disclosure, the signal may be carried by radiating fields or reactive near fields through the space divider, and in such cases the concentration of the power flow within said device may be ubiquitous. A power flow through an aperture, however, may be more specifically defined.

A total power received by an aperture may be defined as the product of the effective receiving aperture and the incident field intensity.

Effective aperture of a radiator, sometimes referred to as receiving aperture or an antenna aperture, may not be equal to a physical dimensions of the same. It is well known that the aperture of an antenna may be characterized by the gain, directivity and efficiency of the antenna, and said aperture may be used to calculate how much an antenna receives power from a certain direction from a certain incident power density of an electromagnetic wave. Hence, it is well known that an aperture is a function of direction as well as polarization similarly to the gain of an antenna. For an antenna that has clearly detectable feeding terminal, said received power can be detected in this terminal. However, in case of a clearly detectable terminal is lacking, the received power may be stored in the electric and magnetic fields of the antenna (or a resonator acting as an antenna), or the device comprising said antenna. In such cases the power received by said device may be characterized by the surface of an imaginary volume enclosing said device. The volume defines a surface through which both the incident and scattered waves flow. The power flow through the surface in an arbitrary solid angle may be characterized by the receiving aperture and intensity of the propagating electromagnetic wave related to the solid angle.

For the sake of clarity, it is defined that in the scope of this document, a physical aperture comprises physical dimensions and physical surface area of a certain structure. Antenna area/aperture, receiving area/aperture, or effective area/aperture define an imaginary area or an aperture, which characterizes the radiation properties of an object, including receiving and emitting an electromagnetic wave. The effective aperture is related to a gain or directivity of an object, which may be characterized by the RCS, and is dependent on polarization, frequency and angles of observation of any of the related waves.

A scattering device for bistatic radar cross section enhancement

FIG. 1a shows an abstraction of the device 501 of the present disclosure, in accordance with an embodiment. The figure shows an example of a space divider 90, and a space of an incident electromagnetic wave, denoted as a first side 80 of the space divider 90, and a space of the scattered electromagnetic wave, denoted as a second side 81 of the space divider. The space divider 90 comprises a discontinuity region 101, which may be a physical opening in a wall 100 or a construction supply, or a discontinuity region between two heterogeneous surfaces or shadowing objects. Illustrative but non-exclusive examples of the latter may be, for example, a seam between a window and a wall, a seam between a sash and a frame of a window or a door, or the like. A device 501 according to the present disclosure may be arranged in said discontinuity region 101.

According to an embodiment, the space divider 90 comprises a shadowing object, a construction supply, or a combination of two or more heterogeneous surfaces, where said space divider 90 is characterized by attenuating electromagnetic signals at a first frequency range at least by 6 dB.

According to an embodiment of the present disclosure, there is provided a device 501 for repeating wireless electromagnetic signals from the first side 80 of the space divider to the second side 81 of the space divider 90, the device 501 is adapted to provide at least two discriminated communication channels 630, 631 (FIG. 1b) at a first frequency range between the two spaces separated by the space divider 90. Said at least two discriminated communication channels comprise a first communication channel 630 and a second communication channel 631, where said first communication channel 630 is characterized by carrying the electromagnetic energy carried by a first incident polarization component 611 of an incident electromagnetic signal at the first frequency, and said second communication channel 631 is characterized by carrying the electromagnetic energy carried by a second incident polarization component 612 of an incident electromagnetic signal at the first frequency, where said first incident polarization component 611 and said second incident polarization component 612 are crossing polarizations.

According to another embodiment, said first communication channel 630 and said second communication channel 631 are characterized by carrying the electromagnetic energy that is re-radiated by said device 501 in at least two re-radiated signals 603 in two crossing polarizations to the second side 81 of the space divider 90, where said at least two re-radiated signals 603 of two crossing polarizations comprise a first re-radiated signal 603′ and a second re-radiated signal 603″, where said first re-radiated signal 603′ is characterized by a first re-radiated polarization component 613 and said second re-radiated signal 603″ is characterized by a second re-radiated polarization component 614, where said first 613 and said second 614 re-radiated polarization components are crossing polarizations.

According to another embodiment, said first communication channel 630 and said second communication channel 631 define at least two discriminated communication channels through said space divider 90, and more specifically from the first side 80 of the space divider 90 to the second side 81 of the space divider 90 in an arrangement where the device 501 is arranged to receive at least two signals of crossing polarizations from the first side 80, and to re-radiate said at least two signals of crossing polarizations to the second side 81 of the space divider 90 at the first frequency range. Said at least two crossing polarizations may be defined in the same crossing planes on both sides of the space divider 90. Furthermore, said at least two crossing polarizations may also be defined in differing crossing planes on both sides of the space divider 90, in which case at least one of the polarization planes are depolarized by said device 501.

FIG. 1b shows an abstraction of the first 630 and the second 631 communication channels, in accordance with an embodiment. The first communication channel 630 refers to a first diversity channel at a first frequency range, and the second communication channel 631 refers to a second diversity channel at the first frequency range. It is appropriate to refer to said first and second diversity channels with numeral 630 and 631 in order to highlight the minimal cross correlation intended for said two channels throughout the entire scattering procedure. Said communication channels 630 and 631 define said at least two discriminated communication channels at the first frequency range between the two spaces separated by the space divider 90.

FIG. 1b describes how the first communication channel 630 and the second communication channel 631 cover the signal flow from the first side 80 of the space divider 90 to the second side 81 of the space divider, where an incident electromagnetic signal 601 is scattered to the second side 81 of the space divider through the device 501 of the present disclosure. Guided electromagnetic signal 602 is carried by the device 501, and re-radiated to the second side 81 of the space divider 90 as a re-radiated electromagnetic signal 603.

In accordance with an embodiment of the present disclosure, the first communication channel 630 defines a signal flow for a first incident electromagnetic signal 601′ characterized by having the first incident polarization component 611 as the main polarization orientation at the first frequency range, where said first incident electromagnetic signal 601′ is guided by the device 501 from the first side 80 of the space divider 90 to the second side 81 of the space divider 90 as a guided electromagnetic signal 602′, which is scattered by the device 501 to the second side 81 of the space divider 90 as a first re-radiated electromagnetic signal 603′, where said re-radiated electromagnetic signal 603′ is characterized by having a first re-radiated polarization component 613 as the main polarization orientation at the first frequency range.

In accordance with an embodiment of the present disclosure, the second communication channel 631 defines a signal flow for a second incident electromagnetic signal 601″ characterized by having the second incident polarization component 612 as the main polarization orientation at the first frequency range, where said second incident electromagnetic signal 601″ is guided by the device 501 from the first side 80 of the space divider 90 to the second side 81 of the space divider 90 as a guided electromagnetic signal 602″, which is scattered by the device 501 to the second side 81 of the space divider 90 as a re-radiated electromagnetic signal 603″ characterized by having a second re-radiated polarization component 614 as the main polarization orientation at the first frequency range.

In accordance with an embodiment of the device 501 of the present disclosure, the first incident polarization component 611 and the second incident polarization component 612 are crossing polarizations.

In accordance with an embodiment of the device 501 of the present disclosure, the first re-radiated polarization component 613 and the second re-radiated polarization component 614 are crossing polarizations.

In accordance with an embodiment of the device 501 of the present disclosure, the first incident polarization component 611 and the second incident polarization component 612 are orthogonal polarizations.

In accordance with an embodiment of the device 501 of the present disclosure, the first re-radiated polarization component 613 and the second re-radiated polarization component 614 are orthogonal polarizations.

In accordance with an embodiment of the device 501 of the present disclosure, at least one of the first incident polarization component 611 and the second incident polarization component 612 is circular polarization.

In accordance with an embodiment of the device 501 of the present disclosure, at least one of the first re-radiated polarization component 613 and the second re-radiated polarization component 614 is circular polarization.

In accordance with an embodiment of the device 501 of the present disclosure, the device 501 is arranged to depolarize at least one of the signals received in said first 611 and second 612 polarization before re-radiating said signals to the second side of the space divider in two crossing polarizations of said first 613 and second 614 re-radiated polarization components. Therefore, in an embodiment of the present disclosure, the first received polarization component 611 and the first re-radiated polarization component 613 may be aligned parallel with respect to each other, and in another embodiment of the present disclosure, the first received polarization component 611 and the first re-radiated polarization component 613 may be aligned crosswise with respect to each other.

For the sake of clarification, it is stated that the first polarization component 611 and the second polarization component 612 refer to the orientations of the main polarization axis of the first incident electromagnetic signal 601′ and the second incident electromagnetic signal 601″, respectively. It is obvious for anyone skilled in the art that the polarization of an electromagnetic wave may be linear, elliptical, or circular.

In accordance with an embodiment, in the examples of FIGS. 1a and 1b, there is provided the first communication channel 630 from the first side 80 of the space divider 90 to the second side 81 of the space divider 90, characterized by said first incident electromagnetic signal 601′, said guided electromagnetic signal 602′, and said re-radiated electromagnetic signal 603′ at the first frequency range, where said first incident electromagnetic signal 601′ is characterized by having the polarization defined by said first incident polarization component 611 and said re-radiated electromagnetic signal 603′ is characterized by having the polarization defined by said first re-radiated polarization component 613. Said incident electromagnetic signal 601′ is characterized by having an intensity, denoted as S1i. Said re-radiated electromagnetic signal 603′ is characterized by having an intensity, denoted as S1s. The bistatic radar cross section (RCS) for said first communication channel 630 is characterized by the relation of S1i and S1s. The bistatic radar cross section for said first communication channel 630 through the device 501 may be calculated using the relation σ1=4π(S1s/S1i) with certain parameters.

The bistatic radar cross section (RCS), as well as the parameters for the same may be a function of angle of incidence, observation angle for the scattered wave, frequency, polarization, as well as the characteristics of the device 501 and the space divider 90.

In accordance with an embodiment, in the examples of FIGS. 1a and 1b, there is provided the second communication channel 631 from the first side 80 of the space divider 90 to the second side 81 of the space divider 90, characterized by said incident electromagnetic signal 601″, said guided electromagnetic signal 602″, and said re-radiated electromagnetic signal 603″ at the first frequency range, where said incident electromagnetic signal 601″ is characterized by having the polarization defined by said second incident polarization component 612 and said re-radiated electromagnetic signal 603″ is characterized by having the polarization defined by said second re-radiated polarization component 614. Said incident electromagnetic signal 601″ is characterized by having an intensity, denoted as S2i. Said re-radiated electromagnetic signal 603″ is characterized by having an intensity, denoted as S2s. The bistatic radar cross section (RCS) for said second communication channel 631 is characterized by the relation of S2i and S2s. The bistatic radar cross section for said second communication channel 631 through the device 501 may be calculated using the relation σ2=4π(S2s/S2i) with certain parameters.

According to an embodiment of the present disclosure, the device 501 may be characterized by having an effective receiving aperture 700′ for capturing electromagnetic energy from the incident electromagnetic signal 601′ from the first side 80 of the space divider 90. The power received by the device 501 from said signal 601′ may be calculated as

P1i=S1i*A1_i_eff,

where A1_i_eff is the effective receiving aperture of the device 501 for said signal 601′. The effective receiving aperture A1_i_eff is denoted by 700′ in FIG. 1a. Said effective receiving aperture is characterized by the radiation pattern of the device 501 on the first side 80 of the space divider 90, as well as directivity and electromagnetic losses, and is a function of angles phi and theta, polarization, and frequency.

According to an embodiment of the present disclosure, the device 501 may be characterized by having an effective re-radiating aperture 701′ for re-radiating electromagnetic energy received from the incident electromagnetic signal 601′ from the first side 80 of the space divider 90, to the second side 81 of the space divider 90. The power (P1i) received by the device 501 from said signal 601′ is scattered, i.e., re-radiated by the device 501 to the second side 81 of the space divider 90. Said re-radiated power, denoted as P1s, may be calculated as

P1s=S1s*A1_s_eff,

where A1_s_eff is the effective re-radiating aperture of the device 501 for the signal 603′. The effective re-radiating aperture A1_s_eff is denoted by 701′ in FIG. 1a. Said effective re-radiating aperture is characterized by the radiation pattern of the device 501 on the second side 81 of the space divider 90, as well as directivity and electromagnetic losses, and is a function of angles phi (φ) and theta (Θ), polarization, and frequency.

According to an embodiment of the present disclosure, the device 501 may be characterized by having an effective receiving aperture 700″ for capturing electromagnetic energy from the incident electromagnetic signal 601″ from the first side 80 of the space divider 90. The power received by the device 501 from said signal 601″ may be calculated as

P2i=S2i*A2_i_eff,

where A2_i_eff is the effective receiving aperture of the device 501 for said signal 601″. The effective receiving aperture A2_i_eff is denoted by 700″ in FIG. 1a. Said effective receiving aperture is characterized by the radiation pattern of the device 501 on the first side 80 of the space divider 90, as well as directivity and electromagnetic losses, and is a function of angles phi and theta, polarization, and frequency.

According to an embodiment of the present disclosure, the device 501 may be characterized by having an effective re-radiating aperture 701″ for re-radiating electromagnetic energy received from the incident electromagnetic signal 601″ from the first side 80 of the space divider 90, to the second side 81 of the space divider 90. The power (P2i) received by the device 501 from said signal 601″ is scattered, i.e., re-radiated by the device 501 to the second side 81 of the space divider 90. Said re-radiated power, denoted as P2s, may be calculated as

P2s=S2s*A2_s_eff,

where A2_s_eff is the effective re-radiating aperture of the device 501 for the signal 603″. The effective re-radiating aperture A2_s_eff is denoted by 701″ in FIG. 1a. Said effective re-radiating aperture is characterized by the radiation pattern of the device 501 on the second side 81 of the space divider 90, as well as directivity and electromagnetic losses, and is a function of angles phi (φ) and theta (Θ), polarization, and frequency.

On the bistatic radar cross section in two beams

According to an embodiment of the present disclosure, the device 501 comprises a dual polarized repeater 500.

According to an embodiment of the present disclosure, said dual polarized repeater 500 is adapted to be installed into a discontinuity region 101 of the space divider to create said at least two discriminated communication channels 630 and 631 by providing an increment of the bistatic radar cross section (RCS) through said discontinuity region 101 for a signal received at said first incident polarization component 611 and for a signal received at said second incident polarization component 612. Said increment in the bistatic radar cross section in said two crossing polarizations may be translated into an increment of the scattered field intensities S1s and S2s in two crossing polarizations 613 and 614 on the second side 81 of the space divider 90.

According to an embodiment of the present disclosure, said increment of the bistatic radar cross section (RCS) through said discontinuity region 101 may be characterized by the increment of the scattered field intensity S1s and S2s of the two re-radiated signals 603′ and 603″ in crossing polarizations, where the first re-radiated signal 603′ is polarized according to the first re-radiated polarization component 613 and the second re-radiated signal 603″ is polarized according to the second re-radiated polarization component 614, and further where said increase of the scattered field intensity (S1s) of the first re-radiated signal 603′ is arranged in a first beam 803, and said increase of the scattered field intensity (S2s) of the second re-radiated signal 603″ is arranged in a second beam 804.

According to an embodiment of the present disclosure, said first 803 and second 804 beams are arranged on the second side 81 of the space divider 90. Said first beam 803 is primarily characterized by having a polarization according to the first re-radiated polarization component 613 as well as a beam width (pi in the azimuth plane and Θ1 in the elevation plane. Said second beam 804 is primarily characterized by having a polarization according to the second re-radiated polarization component 614 as well as a beam width φ2 in the azimuth plane and Θ2 in the elevation plane. The rotation angles of theta (Θ) and phi (φ) are presented in the example shown in FIG. 1a.

The orientation of the space divider 90 in FIG. 1a is depicted with coordinate axis 802, in which the space divider is arranged on the XZ-plane of said coordinate axis. Spherical coordinates 801 are also shown to represent the orientation of the azimuth angle phi (φ) and the elevation angle theta (Θ). Referring to these coordinates, it can be defined that in the example shown in FIG. 1a, the first side 80 of the space divider 90 may be described with angles of theta ranging from 0° to 180°, and phi ranging from 180° to 360°. Likewise, the second side 81 of the space divider 90 may be described with angles of theta ranging from 0° to 180°, and phi ranging from 0° to 180°.

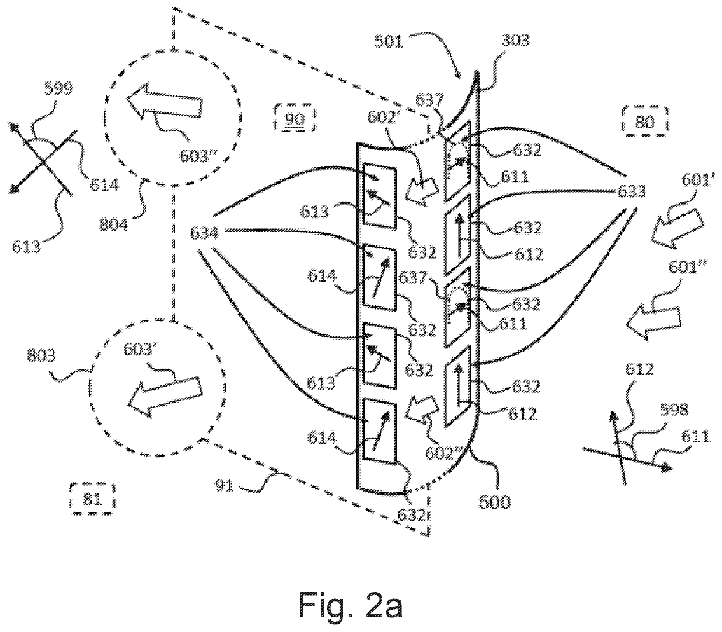

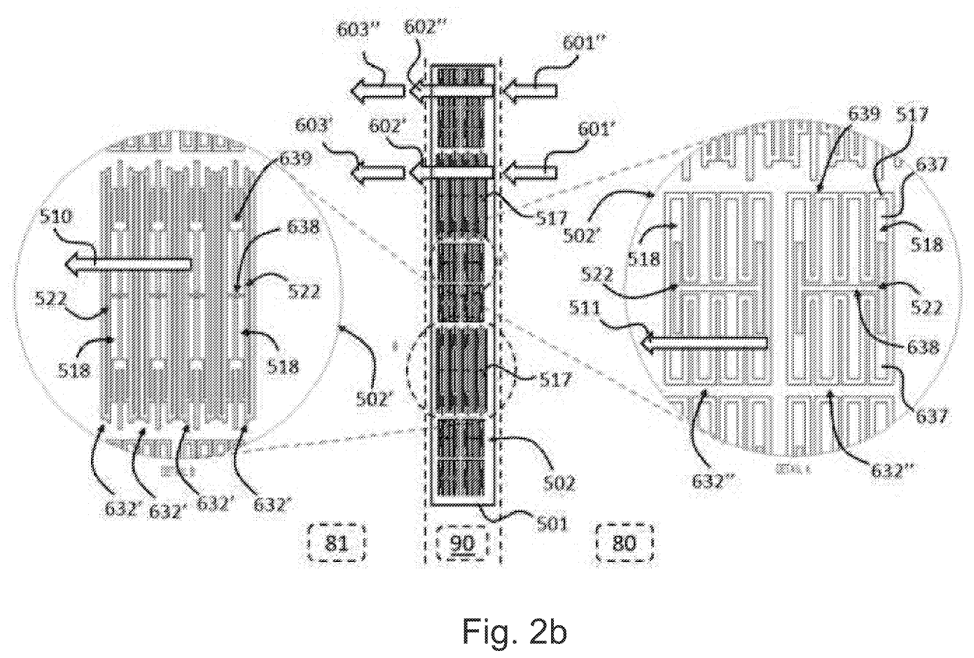

According to an embodiment of the present disclosure, the device 501 comprises a dual polarized repeater 500, said dual polarized repeater 500 comprising a dielectric member 303 (FIG. 2a), and a set of conductive members 517 are arranged as a group of radiators 502 to form said dual polarized repeater 500, where said dual polarized repeater 500 is adapted to be installed into a discontinuity region 101 of the space divider to create said at least two discriminated communication channels 630 and 631 by providing an increment of the bistatic radar cross section (RCS) through said discontinuity region 101 for a first incident signal 601′ received at a first incident polarization component 611 and for a second incident signal 601″ received at a second incident polarization component 612, where at least a part of said first incident signal 601′ is scattered to a first beam 803, and at least a part of said second incident signal 601″ is scattered to a second beam 804 by said device 501, where said first 803 and said second 804 beams are arranged on the second side 81 of the space divider 90.

According to the example shown in FIG. 1a, the first incident signal 601′ is polarized according to the first incident polarization component 611, and the second incident signal 601″ is polarized according to second incident polarization component 612. The device 501 according to the present disclosure may be arranged to maintain the polarization planes of the two incident signal components while re-radiating said components to the second side 81 of the space divider 90. The device 501 according to the present disclosure may also be arranged to modify the polarization planes of the two incident signal components while re-radiating said components to the second side 81 of the space divider 90.

In an embodiment of the present disclosure, the device 501 may be arranged to depolarize at least one of the signals received in said first 611 and second 612 polarization before re-radiating said signals to the second side of the space divider in two crossing polarizations of said first 613 and second 614 re-radiated polarization components.

The device according to the present disclosure may be arranged to enhance the wireless connectivity by reducing the attenuation caused by the space divider 90. In an embodiment, the device 501 may be arranged to support carrier aggregation (CA), where multiple frequency ranges may be supported. In another embodiment, the device 501 may be arranged to support multi connectivity, wherein said arrangement may comprise a plurality of spatially isolated radiation beams and a plurality of supported frequency ranges.

In an embodiment of the present disclosure, said dual polarized repeater 500 may be arranged to create said at least two discriminated communication channels 630, 631 with an arrangement of said first beam 803 and said second beam 804, where said increment of the bistatic RCS is at least 3 dB within said first beam 803 at the first frequency range, and said increment of the bistatic RCS is at least 3 dB within said second beam 804 at the first frequency range.

In an embodiment of the present disclosure, said dual polarized repeater 500 may be arranged to increase the bistatic radar cross section through said discontinuity region 101 at least 3 dB in two crossing polarizations at the first frequency range, where said first frequency range is arranged between 300 MHz and 6000 MHz, and said first frequency range comprises a bandwidth of at least 1 MHz.

In an embodiment of the present disclosure, said dual polarized repeater 500 may be arranged to increase the bistatic radar cross section through said discontinuity region 101 at least 3 dB in two crossing polarizations at a second frequency range, where said first frequency range is arranged between 300 MHz and 1000 MHz, and said second frequency range is arranged between 1400 MHz and 6000 MHz, and both said first and said second frequency ranges comprise a bandwidth of at least 100 MHz.

In an embodiment of the present disclosure, said dual polarized repeater 500 may be arranged to increase the bistatic radar cross section through said discontinuity region 101 at least 3 dB in two crossing polarizations at a third frequency range, where said third frequency range is arranged between 20 GHz and 70 GHz, and said third frequency range comprises a bandwidth of at least 100 MHz.

On the Signal Discrimination in Two Isolated Beams

Wireless communication techniques employ a variety of approaches to enhance the performance of wireless communication channels in terms of e.g. capacity or reliability. Diversity techniques as well as MIMO (Multiple-Input-Multiple-Output) techniques are widely known methods for these purposes.

A common factor for high-performance wireless channels is low correlation between said channels. Both MIMO and diversity receiving methods benefit from having low-correlated communication channels. Correlation between different communication channels depend at least on the properties of the transmitting antennas and the receiving antennas and the multipath communication environment.

Using a repeater for a wireless signal between two separated spaces adds another factor affecting the correlation of the communication channels. A significant part of electromagnetic energy that is transferred from the first side of the space divider to another side of the space divider travels through the repeater. Without proper isolation of the signals during the repeating procedure, the repeater may significantly increase the correlation between two communication channels, and therefore deteriorate the achievable wireless performance.

It is an aim of the present disclosure to provide a device for repeating wireless signals between two sides of a space divider at the first frequency range by providing a separation of said signals during the entire repeating procedure. This requires signal separation, i.e. discrimination at the receiving set of radiators and the re-radiating set of radiators, but also separation during the signal coupling from one side of the space divider to another side of the space divider.

Cross polarization discrimination (XPD) is the ratio of the copolarized received power and the cross-polarized received power. More specifically, XPD describes how much electromagnetic energy is leaked to a second polarization (cross-polarized component) when it is transmitted in a first polarization (co-polar).

In the following, the XPD relating to the present disclosure is described.

FIG. 1c shows an abstraction of the electric fields of the received and scattered signals at the first frequency range, where said scattered signals are emitted in the first 803 and second 804 beams by the device 501, in accordance with an embodiment, as well as the definition of cross polarization discrimination for said signals.

In accordance with an embodiment, the dual polarized repeater 500 is arranged to provide an increment of the bistatic radar cross section through the discontinuity region 101 in two crossing polarizations of a first beam 803, and a second beam 804, where said first beam 803 and said second beam 804 are arranged on the second side 81 of the space divider 90, where, in said arrangement, said dual polarized repeater 500 is adapted to provide cross polarization discrimination (XPD) for the first incident signal 601′ in said first beam 803 and cross polarization discrimination for the second incident signal 601″ in said second beam 804; where, in said arrangement, said first incident signal 601′ is received by the device 501 at a first incident polarization component 611 and said second incident signal 601″ is received by the device 501 at a second incident polarization component (612), where at least a part of said first incident signal 601′ is scattered to the first beam 803, and at least a part of said second incident signal 601″ is scattered to the second beam 804 by said device 501, where said first beam 803 and said second beam 804 are arranged on the second side 81 of the space divider 90.

In accordance with an embodiment, the dual polarized repeater 500 is adapted to provide cross polarization discrimination (XPD1) for said first incident signal (601′) in said first beam (803), and said dual polarized repeater 500 is adapted to provide cross polarization discrimination (XPD2) for said second incident signal 601″ in said second beam 804.

In accordance with an embodiment of the present disclosure, the first communication channel 630 defines a signal flow for the first incident electromagnetic signal 601′ characterized by having the first incident polarization component 611 as the main polarization orientation at the first frequency range, where said first incident signal 601′ is guided by the device 501 from the first side 80 of the space divider 90 to the second side 81 of the space divider 90 as a guided electromagnetic signal 602′, which is scattered by the device 501 to the second side 81 of the space divider 90 as a first re-radiated electromagnetic signal 603′ characterized by having a first re-radiated polarization component 613 as the main polarization orientation at the first frequency range.

In accordance with an embodiment, in the examples of FIGS. 1a-1c, there is provided the first communication channel 630, characterized by the incident electromagnetic signal 601′, the guided electromagnetic signal 602′, and the re-radiated electromagnetic signal 603′ at the first frequency range, where said incident electromagnetic signal 601′ is characterized by having the polarization defined by said first incident polarization component 611 and said re-radiated electromagnetic signal 603′ is characterized by having the polarization defined by said first re-radiated polarization component 613, and further, there is provided the second communication channel 631, characterized by the incident electromagnetic signal 601″, the guided electromagnetic signal 602″, and the re-radiated electromagnetic signal 603″ at the first frequency range, where said incident electromagnetic signal 601″ is characterized by having the polarization defined by said second incident polarization component 612 and said re-radiated electromagnetic signal 603″ is characterized by having the polarization defined by said second re-radiated polarization component 614.

The example shown in FIG. 1c presents an abstraction of the electric fields of the received and scattered signals at the first frequency range, in accordance with an embodiment. The electric field vector of the first incident polarization component 611 is referred to as symbol E1. The electric field vector of the second incident polarization component 612 is referred to as symbol E2. Both said vectors of E1 and E2 are related to the electromagnetic energy that illuminates the device 501 of the present disclosure from the first side 80 of the space divider 90.

According to an embodiment, on the second side 81 of the space divider 90, said first re-radiated polarization component 613 comprises at least a first vector component 613′ and a second vector component 613″, and said second re-radiated polarization component 614 comprises at least a third vector component 614′ and a fourth vector component 614″.

The electric field vector of said first vector component 613′ is referred to as symbol E11. It is characterized by the main polarization component which is scattered by the device 501 to the second side 81 of the space divider, when the illuminating polarization is E1 (i.e. 611) on the first side 80 of the space divider 90. This component E11 may be called as a “co-polarized” component to E1, in case the depolarization by the device 501 is not considerable.

The electric field vector of said third vector component 614′ is referred to as symbol E22. It is characterized by the main polarization component which is scattered by the device 501 to the second side 81 of the space divider, when the illuminating polarization is E2 (i.e. 612) on the first side 80 of the space divider 90, when 611 and 612 are crossing polarizations. This component E22 may be called as a “co-polarized” component to E2, in case the depolarization by the device 501 is not considerable.

The electric field vector of said second vector component 613″ is referred to as symbol E21. It is primarily characterized by being an orthogonal component to E22 on the second side 81 of the space divider, when the illuminating polarization is E2 (i.e. 612) on the first side 80 of the space divider 90.

The electric field vector of said fourth vector component 614″ is referred to as symbol E12. It is primarily characterized by being an orthogonal component to E11 on the second side 81 of the space divider, when the illuminating polarization is E2 (i.e. 612) on the first side 80 of the space divider 90.

It is an aim of the aspects of the disclosed embodiments to suppress the amount of electromagnetic energy that is leaked to an unwanted cross polarized component on the second side 81 of the space divider 90 in a given solid angle, when the device 501 is illuminated from the first side 80 with a certain polarization. More specifically, it is an aim to suppress the amount of electromagnetic energy that is leaked to the second re-radiated polarization component 614, when the device 501 is illuminated with a signal 601 having the main polarization component characterized by the first incident polarization component 611, and to suppress the amount of electromagnetic energy that is leaked to the first re-radiated polarization component 613, when the device 501 is illuminated with a signal 601 having the main polarization component characterized by the second incident polarization component 612. The aforementioned aspect of the present disclosure is of significant importance for providing at least two discriminated communication channels (i.e. diversity or MIMO channels) between the two spaces separated by the space divider 90.

The suppression of the leakage of the electromagnetic energies to the unwanted polarization components may be characterized by the cross polarization discrimination (XPD).

The cross polarization discrimination for the first communication channel 630 through the device 501 (XPD1) may be defined as the cross polarization discrimination for said first incident signal 601′ in said first beam 803, and it may be calculated as XPD1=20*log(E11/E12) as shown in FIG. 1c.

The cross polarization discrimination for the second communication channel 631 through the device 501 (XPD2) may be defined as the cross polarization discrimination for said second incident signal 601″ in said second beam 804, and it may be calculated as XPD2=20*log(E22/E21) as shown in FIG. 1c.

In an embodiment of the present disclosure, said dual polarized repeater 500 may be arranged to create said at least two discriminated communication channels 630, 631 with an arrangement of said first beam 803 and said second beam, where said increment of the bistatic RCS is at least 3 dB and said XPD is at least 6 dB within said first beam 803 at the first frequency range, and said increment of the bistatic RCS is at least 3 dB and said XPD is at least 6 dB within said second beam 804 at the first frequency range.

Envelope correlation coefficient (ECC) may be used to quantify the correlation between the radiated signal components in a given space or a space angle. There exists analysis methods for ECC that are based on the mutual coupling of separated antenna elements with certain assumptions. A more general definition for ECC is based on radiated far fields, and this definition is well known. In a MIMO- or a diversity system, both ECC and XPD relate to the achievable performance limits of said systems.

In an embodiment of the present disclosure, said dual polarized repeater 500 may be arranged to create said at least two discriminated communication channels 630, 631 with an arrangement of said first beam 803 and said second beam 804, where the envelope correlation coefficient (ECC) for the first incident signal 601′ and the second incident signal 601″ in said first beam 803 is less than 0.8 at the first frequency range, and further where the envelope correlation coefficient for the first incident signal 601′ and the second incident signal 601″ in said second beam 804 is less than 0.8 at the first frequency range.

Cyclic Delay Diversity

Cyclic delay diversity (CCD) is a diversity scheme that is commonly used in wireless communications to provide a copy of a certain signal component that is delayed before transmission by a wireless radio. In wireless radio architecture, it is known as a virtual echo. By using such virtual echoes, the diversity reception properties of a receiver may be enhanced, because the reception of a delayed copy of a signal component reduces the probability of fast fading nulls. In an embodiment of the present inve, the cyclic delay diversity may be provided by the device 501 by arranging a delay between the two signal components that are scattered from the first side of the space divider to the second side of the space divider.

A guard interval known as cyclic prefix (CP) is commonly used in OFDM (Orthogonal Frequency-Division Multiplexing) transmissions, e.g. in LTE (Long Term Evolution) networks. Cyclic prefix is a way to avoid inter symbol interference (ISI) due to unwanted echoes, i.e. delay spread, and the optimal length of cyclic prefix depends on the scattering environment. In areas with relatively small (RMS) delay spread, a smaller cyclic prefix interval may be used than in wide open areas where (RMS) delay spread is relatively large. In LTE, a normal CP of 4.7 μs (microseconds), and an extended CP of 16.67 μs is defined by 3GPP (3^{rd} Generation Partnership Project). In order to enhance the cyclic delay diversity, the device 501 according to the present disclosure may provide a delayed echo of a signal component, where the delay is considerably smaller than the cyclic prefix of the signal is repeated.

In an embodiment of the present disclosure, the device is arranged to enhance cyclic delay diversity by providing at least one delayed signal component, said at least one delayed signal component is delayed from said first incident signal 601′ or said second incident signal 601″ by a delay.

In 5G networks, the OFDM subcarrier spacing, symbol length, and thus also the cyclic prefix is more scalable, and may be smaller than the normal cyclic prefix of the LTE network. At frequencies lower than 6 GHz, typical OFDM subcarrier spacing varies from 15 kHz to 60 kHz, and the corresponding cyclic prefix from 4.7 to 1.2 μs. Furthermore, in small cells, where higher than 6 GHz frequencies have the largest potential, subcarrier spacing from 120 kHz to 480 kHz become efficient, and the corresponding cyclic prefix may vary from 0.59 μs to 0.15 μs.

In an embodiment of the present disclosure, the device is arranged to enhance cyclic delay diversity by providing at least one delayed signal component, said delayed signal component is delayed from said first incident signal 601′ or said second incident signal 601″ by a delay, where said delay is larger than 0 μs and smaller than 1.2 μs and the first frequency is less than 6 GHz, or said delay is longer than 0 μs and shorter than 0.15 μs and the first frequency is higher than 6 GHz

Set of Resonators

For the sake of clarification, electrical conductivity may be referred to as conductive/conductivity in this document, and a thermal conductivity shall always be referred to with a prefix “thermal” (as in thermally conductive material).

A radiator is formed by a source of radiating electromagnetic field. A radiator operates at a first frequency range, and the radiator can be generally classified as a magnetic or electric radiator based on the behaviour of said fields in the vicinity of the radiator. A source of radiation can be an oscillating electric field, or an oscillating magnetic field, or both. A radiator may be formed by a conductive member, or a plurality of conductive members. Moreover, a conductive member may comprise a plurality of radiators at a first frequency.

A resonator 632 is formed by a conductive member 517, where a standing wave pattern of electric fields and magnetic fields or surface currents can occur. More precisely, a resonator 632 is a conductive member, which favors electromagnetic resonance at a first frequency. An electromagnetic resonance is a natural oscillation phenomenon within a system, in which the electromagnetic energy of the oscillating system is primarily stored on the electric fields on one phase of the oscillation cycle, and on magnetic fields of the system on another phase of the oscillation cycle. In a conductive medium, the magnetic energy is closely connected to surface currents as is generally known by the electromagnetic constitutive relations.

The energy loss of a resonator 632 during an oscillation phase comprises both the loss of energy that is transformed to heat, and the loss of radiated energy. A resonator 632 may act as a source of radiating electromagnetic field, i.e. a resonator may be a radiator.

FIG. 2a shows an abstraction of the device 501 in accordance with an embodiment, where the space divider 90 comprises an electrically conductive layer 91, and FIG. 2b shows an example of the device 501 in accordance with an embodiment. In the example of FIG. 2b, there is shown one possible physical implementation of the device 501, which may be arranged to operate at several frequency ranges.

It is an aim of the present disclosure provide a device 501 that is adapted to provide at least two discriminated communication channels 630, 631 at a first frequency range between the two spaces separated by the space divider 90.

According to an embodiment, said device 501 comprises a dual polarized repeater 500, and a set of conductive members 517 arranged as a group of radiators 502 to form said dual polarized repeater 500.

According to an embodiment, said group of radiators 502 comprises a first set of resonators 633 and a second set of resonators 634.

According to an embodiment, said group of radiators 502 comprises said first set of resonators 633, where said first set of resonators 633 is arranged to receive and discriminate signals of said first 611 and a second 612 incident polarization components at the first frequency range from the first side of the space divider 90, where said first 611 and second 612 incident polarization components are crossing polarizations, and where said first set of resonators 633 is arranged to receive said first polarization component 611 by a plurality of resonant gaps 637, where said plurality of resonant gaps 637 are arranged within a plurality of conductive members 517.

According to an embodiment, said group of radiators 502 comprises said second set of resonators 634, where said second set of resonators 634 is arranged to form said first beam 803 and said second beam 804, where said first beam 803 is characterized by having a polarization according to the first re-radiated polarization component 613 and said second beam 804 is characterized by having a polarization according to the second re-radiated polarization component 614, where said first 613 and second 614 re-radiated polarization components are crossing polarizations.

In the example shown in FIG. 2a, there is presented the first incident polarization component 611 and the second incident polarization component 612 on the first side 80 of the space divider 90, where the angle 598 between said crossing components is shown. There is also presented the first re-radiated polarization component 613 and the second re-radiated polarization component 614 on the second side 81 of the space divider 90, where the angle 599 between said crossing components is shown.

According to an embodiment, said group of radiators 502 may comprise a conductive member 517, where said conductive member 517 comprises at least one resonator 632 that belongs to said first set of resonators 633, and at least one resonator 632 that belongs to said second set of resonators 634.

In the example shown in FIG. 2a, the device 501 comprises the first 633 and the second 634 set of resonators. Said first set of resonators 633 may be arranged to receive said first polarization component 611 by a plurality of resonant gaps 637, where said plurality of resonant gaps 637 is arranged within a plurality of conductive members 517. FIG. 2b shows an example of the plurality of resonant gaps 637 arranged within a plurality of conductive members 517.

In an embodiment of the present disclosure, the resonant gap 637 is arranged within an electrically non-conductive region 518 of a resonator 632.

In an embodiment of the present disclosure, the resonant gap 637 is arranged between edges of conductive members 517 of a resonator 632, where said edges of conductive members 517 define at least partly an electrically non-conductive region 518 within said resonator 632, where said non-conductive region 518 and said conductive members 517 define said resonator 632.

In the example shown in FIG. 2b, there is shown a device 501, which is arranged to operate at a plurality of frequency ranges. There is also shown an example of an embodiment having a coupling member 522, and examples of at least two isolated connections 638 and 639 to connect the first incident electromagnetic signal 601′ to the first beam 803 and the second incident electromagnetic signal 601″ to the second beam 804 for providing the at least two discriminated communication channels 630 and 631 at a first frequency range.

The device 501 according to an embodiment, may be used to enhance the communication over a wireless network by providing an enhancement for carrier aggregated channels. Carrier aggregation may be used to enhance the capacity of wireless networks by combining a plurality of frequency ranges for the use of separated wireless nodes, or a node and a base station.

In an embodiment of the present disclosure, the dual polarized repeater 500 may be arranged to operate at the first frequency range and at the second frequency range. In another embodiment of the present disclosure, the dual polarized repeater 500 may be arranged to operate at the first, second and a third frequency range, at which said plurality of frequency ranges, in at least two separated frequency ranges, said dual polarized repeater 500 is adapted to provide at least two discriminated communication channels between the two spaces separated by the space divider 90.

In an embodiment of the present disclosure, the dual polarized repeater 500 may be arranged to increase the bistatic radar cross section through said discontinuity region 101 at least 3 dB in two crossing polarizations at the first frequency range, and a second frequency range, where said first frequency range is arranged to be between 300 MHz and 1000 MHz, and said second frequency range is arranged to be between 1400 MHz and 6000 MHz, and both said first and said second frequency ranges comprise a bandwidth of at least 100 MHz. Said combined frequency ranges may be used for carrier aggregated networks.

In an embodiment of the present disclosure, the dual polarized repeater 500 is arranged to increase the bistatic radar cross section through said discontinuity region 101 at least 3 dB in two crossing polarizations in at the two of the first, second, and a third frequency range, where said first frequency range is arranged to be between 300 MHz and 1000 MHz, said second frequency range is arranged to be between 1400 MHz and 6000 MHz, and said third frequency range is arranged to be between 20 GHz and 70 GHz, and further where said first, second, and third frequency ranges comprise a bandwidth of at least 100 MHz.

In the example shown in FIG. 2b, there is shown a transmission channel of the first frequency range 510, which is arranged at the first frequency, and a transmission channel 511 which is arranged at the second frequency range.

Transmission channel of the first frequency range 510 comprises the at least two discriminated communication channels 630 and 631 at the first frequency range, where said first communication channel 630 is characterized by the first incident electromagnetic signal 601′, the first guided electromagnetic signal 602′, and by the first re-radiated electromagnetic signal 603′ and said second communication channel 631 is characterized by the second incident electromagnetic signal 601″, the second guided electromagnetic signal 602″, and by the second re-radiated electromagnetic signal 603″ at the first frequency range.

Transmission channel of the second frequency range 511 comprises the at least two discriminated communication channels 630 and 631 at the second frequency range, where said first communication channel 630 is characterized by the first incident electromagnetic signal 601′, the first guided electromagnetic signal 602′, and by the first re-radiated electromagnetic signal 603′ and said second communication channel 631 is characterized by the second incident electromagnetic signal 601″, the second guided electromagnetic signal 602″, and by the second re-radiated electromagnetic signal 603″ at the second frequency range.

In the example of FIG. 2b, the members of the group of radiators 502, which are arranged to operate at the first frequency range, and referred to as a numeral 502′, and the members of the group of radiators 502, which are arranged to operate at the second frequency range, and referred to as a numeral 502″. The resonators operating at the first frequency range are referred to as numeral 632′, and the resonators operating at the second frequency range are referred to as numeral 632″.

The first set of resonators 633 is a set of resonators 632 which are arranged to resonate at least at the first frequency range, where the resonating electric fields of said resonators is primarily induced by the electromagnetic energy carried by the incident electromagnetic signals 601′ and 601″ on the first side 80 of the space divider 90.

The second set of resonators 634 is a set of resonators 632 which are arranged to resonate at least at the first frequency range, and where the resonating electric fields of said second set of resonators 634 is primarily induced by the electromagnetic energy that is received by the first set of resonators 633, and is connected from the first set of resonators 633 to the second set of resonators 634.

In an embodiment of the present disclosure, the first set of resonators 633 comprise a plurality of separate resonators 632.

In an embodiment of the present disclosure, the first set of resonators 633 comprise resonators 632, which are arranged to receive the first polarization component 611 from the first side 80 of the space divider 90.

In an embodiment of the present disclosure, the first set of resonators 633 comprise resonators 632, which are arranged to receive the second polarization component 612 from the first side 80 of the space divider 90.

In an embodiment of the present disclosure, the first set of resonators 633 comprise resonators 632, which are arranged with a single conductive member, the conductive member comprising a plurality of resonating regions which are arranged to receive the first polarization component 611 at a first frequency from the first side 80 of the space divider 90.

In an embodiment of the present disclosure, the first set of resonators 633 comprise at least two resonators 632, which are arranged to receive the first polarization component 611 from the first side 80 of the space divider 90, and at least two resonators 632, which are arranged to receive the second polarization component 612 from the first side 80 of the space divider 90.

In an embodiment of the present disclosure, the second set of resonators 634 is arranged to create said first beam 803 and said second beam 804 on the second side 81 of the space divider 90.

The radiation patterns of the second set of resonators 634 on the second side 81 of the space divider 90 may be advantageously characterized by space angles. The first beam 803 may be characterized by having a polarization according to the first re-radiated polarization component 613 and the second beam 804 may be characterized by having a polarization according to the second re-radiated polarization component 614, where said first 613 and second 614 re-radiated polarization components are crossing polarizations.

The space angles for each of said beams may be characterized by an imaginary (mathematical) unit sphere having a radius of one. The solid angle for a unit sphere is defined with a section of the surface area of said unit sphere. In case the device 500 has a single main beam or a plurality of beams for the enhanced values of the bistatic RCS, the solid angle for the device may also be defined as a sum of separated space angles where a defined criterion is met.

In an embodiment of the present disclosure, said first beam 803 may be arranged to cover a first solid angle on the second side 81 of the space divider 90, and said second beam 804 may be arranged to cover a second solid angle on the second side 81 of the space divider 90, where said first beam 803 and said second beam 804 are arranged to cover substantially separated spherical sectors on the second side 81 of the space divider 90, and where said solid angles are defined by the 3 dB beamwidths of the bistatic RCS pattern.

In another embodiment of the present disclosure, said first beam 803 may be arranged to cover a first solid angle on the second side 81 of the space divider 90, and said second beam 804 may be arranged to cover a second solid angle on the second side 81 of the space divider 90, where said first beam 803 and said second beam 804 are arranged to cover substantially overlapping spherical sectors on the second side 81 of the space divider 90, and where said solid angles are defined by the 3 dB beamwidths of the bistatic RCS pattern.

Resonant Gaps

It is an aim of the present disclosure to provide a device 501 with enhanced capabilities to transmit or receive electromagnetic signals having two crossing polarizations in an assembly where the device is intended to operate through a sub-wavelength passage. The device 501 comprises a dual polarized repeater 500 adapted to be installed into the discontinuity region 101 of the space divider 90.

In an embodiment of the present disclosure, the discontinuity region 101 has a width of less than a wavelength at the first frequency range at least in a first direction. In said embodiment, the discontinuity region may be, for example, an installation gap between a window and a wall, or a gap between two window units. Furthermore, it may be a seam between two construction supplies, where said width may be less than 2 cm. In another embodiment, said device may be integrated with an electrically non-conductive window frame or a cladding of a window frame, in which case said discontinuity region may be less than 10 cm. Further, in another embodiment, said discontinuity region may be a seam between two wall elements, where said wall elements comprise metal layers, and in such case said discontinuity region may be less than 5 mm.

A dipole antenna may be used to receive or radiate polarizations according to the orientation of the dipole. However, in many cases the integration of the repeater is intended to become unnoticeable. This means that a protrusion of the repeater or a part of it outside the space divider 90 may be prohibited. Therefore, a pair of dipoles, or similar half-wavelength antennas may not be feasible to be used for the dual polarized repeater 500. Furthermore, many space dividers may comprise metals in the vicinity of the dual polarized repeater 500. In such cases, the dipole would be preferably needed to protrude in the direction of the normal component to prevent mirror currents. In another case, it could be installed in the direction of the tangential component of the metal layer of the space divider 90 with large distance to the metal in order to diminish mirror currents cancelling the radiating currents of the dipole. Therefore, a dual polarized repeater 500 comprising a resonator 632, where the above drawbacks may be eliminated, is presented.

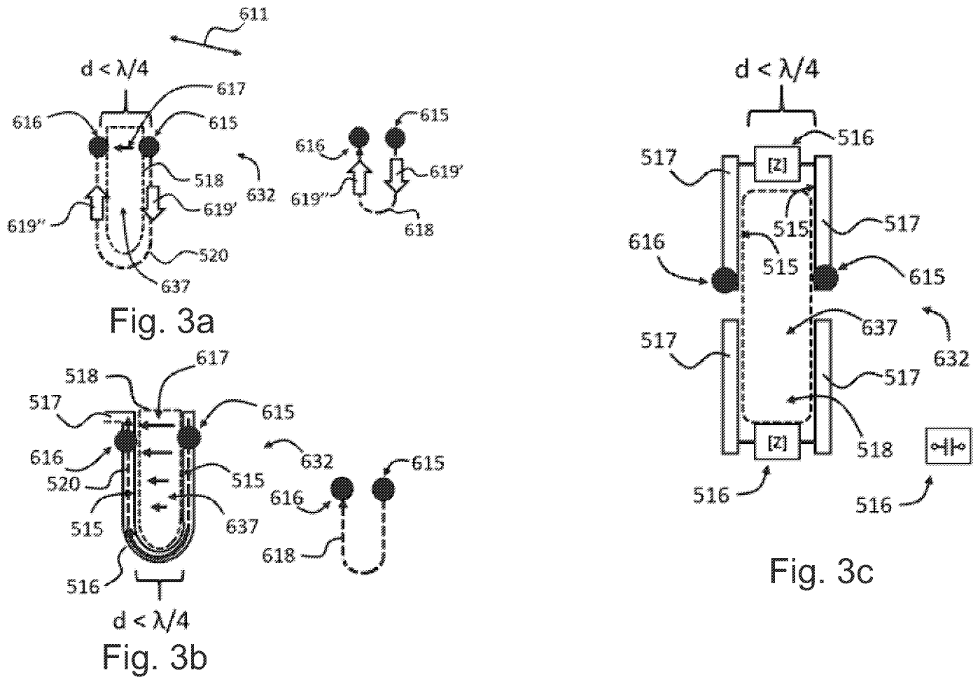

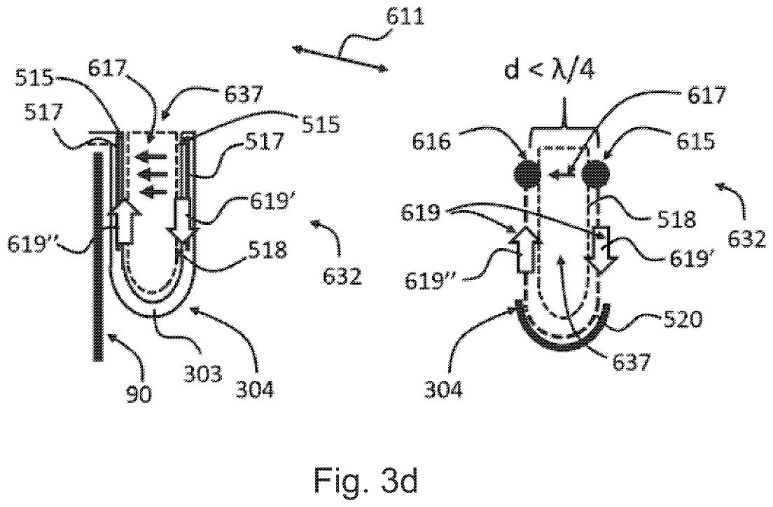

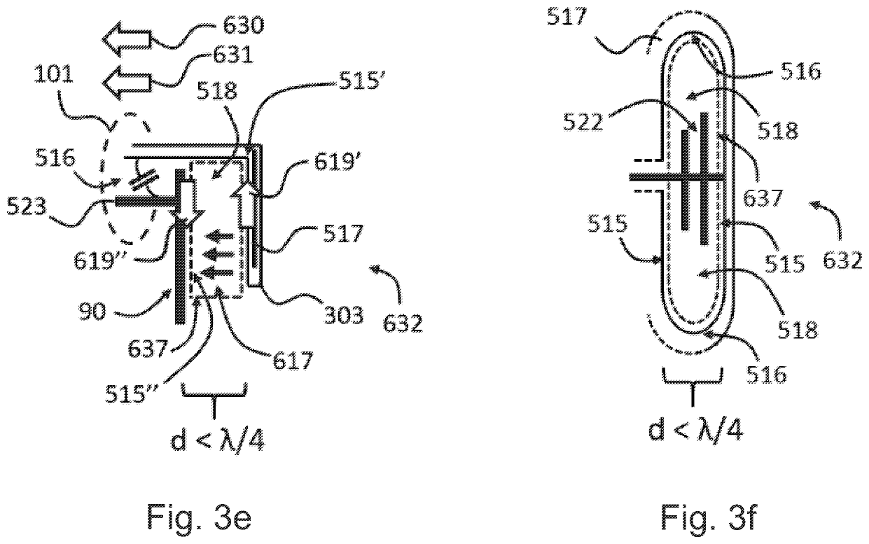

FIGS. 3a-3f present examples of resonators, where the resonant gaps 637 are arranged within electrically non-conductive regions 518 between edges of conductive members 517.

According to an embodiment of the present disclosure, the first 611 and second 612 incident polarization components are crossing polarizations, where the first incident polarization component 611 has a polarization direction essentially directed in a direction that is crossing the direction of the longest dimension of the discontinuity region 101.

As an example of an embodiment, the discontinuity region 101 may be predominantly vertically aligned narrow passage, which has a length of at least two wavelengths at the first frequency of operation in the vertical direction (longitudinal direction), and a width of less than a half wavelength in the horizontal direction. Such discontinuity region 101 could be formed, for example, with the vertical frame of a window or a door, or a seam of a wall element. In such case, the first incident polarization component 611 may be predominantly horizontally polarized. In another example of an embodiment, the discontinuity region 101 may be predominantly horizontally aligned narrow passage, which has a length of at least two wavelengths at the first frequency of operation in the horizontal direction (longitudinal direction), and a width of less than a half wavelength in the vertical direction. Such discontinuity region 101 could be formed, for example, with the horizontal frame of a window or a door, or a seam of a wall element. In such case, the first incident polarization component 611 may be predominantly vertically polarized.

According to an embodiment of the present disclosure, the first set of resonators 633 is arranged to receive and discriminate signals of said first 611 and said second 612 incident polarization components at the first frequency range from the first side of the space divider 90, where said first 611 and second 612 incident polarization components are crossing polarizations, and where said first set of resonators 633 are arranged to receive said first polarization component 611 by a plurality of resonant gaps 637, where said plurality of resonant gaps 637 are arranged within a plurality of conductive members 517.

According to an embodiment of the present disclosure, said plurality of resonant gaps 637 may be arranged by resonators 632, where said resonators 632 comprise electrically non-conductive regions 518 between edges of said conductive members 517, where said non-conductive regions 518 comprise at least a first and a second edge section 515, and a return path 516 arranged between said first and said second edge sections 515, wherein said edge sections 515 and said return path 516 define a curve 520 where said curve 520 coils said non-conductive region 518 and the length of said curve is at least a quarter of a wavelength at the first frequency range, and said return path 516 comprise a low impedance path or a displacement current between charge nodes 615, 616. Furthermore, said resonant gaps 637 may be arranged to induce a positive charge distribution 615, and a negative charge distribution 616 along said curve 520 by the received electromagnetic energy of said first incident polarization component 611, wherein said positive 615 and negative 616 charge distributions are separated by a distance of larger than a quarter of a wavelength at the first frequency range along said curve 520, and where the shortest distance between said positive charge distribution 615 and said negative charge distribution 616 is arranged to less than a quarter of a wavelength at the first frequency range, where further in said arrangement, said positive 615 and said negative 616 charge distributions are arranged to generate a potential difference between said first and said second edge section 515 within said non-conductive region 518, and a current loop 618 oscillating at the first frequency range between two nodes defined by said positive 615 and said negative 616 charge distributions, where said oscillating current loop 618 flows along said curve 520.

According to an embodiment, said current loop 618 comprises a differential current pair 619 along said curve 520, where said differential current pair 619 is characterized of having a current element 619′ flowing in the first direction, and a current element 619″ flowing in a direction that opposes the first direction, and further where said current elements 619′ and 619″ are closely coupled by the electric field 617.

According to an embodiment, said differential current pair 619 may comprise a conduction current element flowing on a conductive member 517 or a displacement current element flowing between conductive members 517, where said displacement current is arranged between charge nodes. Said displacement current may also be arranged through a low impedance path, where said low impedance path may be arranged at the first frequency range with a capacitance, or any of a low pass filter, high pass filter, or a band pass filter.

The presented resonator 632 has a benefit of being capable to operate from a narrow passage without a need for large protrusion. The presented resonator 632 is capable of receiving or radiating polarization components which are predominantly crossing the direction of the conductive members that constitute said resonator, or the direction of the currents flowing in such conductive members. This is very contrary of what happens when a dipole antenna is considered, where the currents are aligned with the direction of the conductive member of the dipole, where further said conductive member defines the orientation of the dipole.

Another benefit of the presented resonator 632 is that it may bound a significant part of the near fields of the resonator within the non-conductive region 518, which makes the resonator more immune to the effects of the closely positioned surrounding metals that could detune the resonator and affect both its impedance and radiation properties. With a dipole antenna, the near fields are more loosely bound by its conductive members, which makes a dipole more sensitive to the detuning effects of the surrounding metals.

FIG. 3a shows an abstraction of the resonator 632, and an example of the curve 520, where said resonator 632 comprises the electrically non-conductive region 518, which may be arranged between edges of conductive members to form the resonant gap 637 at the first frequency range. In FIG. 3a, there is provided the curve 520, where said curve 520 coils said non-conductive region 518 and the length of said curve 520 is at least a quarter of a wavelength at the first frequency range.

Furthermore, in the example of FIG. 3a, the resonant gap 637 may be arranged to induce a positive charge distribution 615, and a negative charge distribution 616 along said curve 520 by the received electromagnetic energy of said first incident polarization component 611, wherein said positive 615 and negative 616 charge distributions are separated by a distance of larger than a quarter of a wavelength at the first frequency range along said curve 520, and where the shortest distance (“d” in FIG. 3a) between said positive charge distribution 615 and said negative charge distribution 616 is arranged to be less than a quarter of a wavelength at the first frequency range, where further in said arrangement, said positive 615 and said negative 616 charge distributions are arranged to generate an oscillating electric field 617 between said charge distributions within said non-conductive region 518, and a current loop 618 oscillating at the first frequency range between two nodes defined by said positive 615 and said negative 616 charge distributions, where said oscillating current loop flows along said curve 520, and where said current loop comprises a differential current pair 619 along said curve 520, where said differential current pair 619 is characterized of having a current element 619′ flowing in the first direction, and a current element 619″ flowing in a direction that opposes the first direction, and further where said current elements 619′ and 619″ are closely coupled by the electric field 617.

In an embodiment of the present disclosure, the first frequency range is arranged to be between 300 MHz and 3000 MHz, and the shortest distance (“d” in FIG. 3a) between said positive charge distribution 615 and said negative charge distribution 616 is less than 25 mm.

In an embodiment of the present disclosure, the first frequency range is arranged to be between 700 MHz and 6000 MHz, and the shortest distance (“d” in FIG. 3a) between said positive charge distribution 615 and said negative charge distribution 616 is less than 12 mm.

FIG. 3b shows an example of the resonator 632, in accordance with an embodiment, where the resonant gap 637 is arranged by the resonator 632, where said resonator 632 comprises the electrically non-conductive region 518 between edges of the conductive member 517, where said non-conductive region 518 comprises at least a first and a second edge sections 515, and a return path 516 arranged between said first and said second edge sections 515, wherein said edge sections 515 and said return path 516 define the curve 520 where said curve 520 coils said non-conductive region 518 and the length of said curve is at least a quarter of a wavelength at the first frequency range, and said return path 516 comprises a low impedance path between charge nodes 615 and 616. Furthermore, said resonant gaps 637 are arranged to induce the positive charge distribution 615, and the negative charge distribution 616 along said curve 520 by the received electromagnetic energy of said first incident polarization component 611, wherein said positive 615 and negative 616 charge distributions are separated by a distance of larger than a quarter of a wavelength at the first frequency range along said curve 520, and where the shortest distance between said positive charge distribution 615, and said negative charge distribution 616 are arranged to be less than a quarter of a wavelength at the first frequency range, where further in said arrangement, said positive 615 and said negative 616 charge distributions are arranged to generate a potential difference and an oscillating electric field 617 between said first and said second edge section 515 within said non-conductive region 518, and a current loop 618 oscillating at the first frequency range between two nodes defined by said positive 615 and said negative 616 charge distributions, where said oscillating current loop 618 flows along said curve 520.

FIG. 3c shows an example of the resonator 632, in accordance with an embodiment, where the resonant gap 637 is arranged by the resonator 632, where said resonator 632 comprises the electrically non-conductive region 518 between edges of conductive members 517, where said non-conductive region 518 comprises at least a first and a second edge sections 515, and a return path 516 arranged between said first and said second edge sections 515, wherein said edge sections 515 and said return path 516 define the curve that coils said non-conductive region 518 and the length of said curve is at least a quarter of a wavelength at the first frequency range, and said return path 516 comprises a displacement current, said displacement current being arranged between conductive members 517. In an embodiment, said return path 516 for the displacement current may be arranged with an impedance (denoted by “Z”), where said impedance comprises a capacitance. In such arrangement the displacement current may be arranged between charged nodes that are arranged on opposite terminals of the capacitance.

According to an embodiment, the return path 516 may be arranged at the first frequency range as a galvanic contact, lumped or distributed capacitive component, lumped or distributed inductive component, active semiconductor component, low pass filter, high pass filter, or band pass filter.

FIG. 3d shows an example in accordance with an embodiment, of a cross section of the resonator 632, where said resonator 632 is arranged with the dielectric member 303, and said resonator 632 is formed by the conductive members 517, where the resonant gap 637 is arranged by the resonator 632, where said resonator 632 comprises the electrically non-conductive region 518 between edges of conductive members 517, where said non-conductive region 518 comprises at least the first and the second edge sections of the conductive member 517, and a fold 304 of said dielectric member 303 between said first and said second edge sections 515, wherein said first and second edge sections 515 and said fold 304 of said dielectric member 303 define a part of the curve 520, where said curve 520 coils said non-conductive region 518 and the length of said curve is at least a quarter of a wavelength at the first frequency range. Furthermore, in the example of FIG. 3d, said resonant gap 637 is arranged to induce a positive charge distribution 615, and a negative charge distribution 616 along said curve 520 by the received electromagnetic energy of said first incident polarization component 611, wherein said positive 615 and negative 616 charge distributions are separated by a distance of less than a quarter of a wavelength at the first frequency range. And further, said positive 615 and said negative 616 charge distributions are arranged to generate a potential difference between said first and said second edge section 515 within said non-conductive region 518, and a differential current pair 619 oscillating along said first and said second edge sections 515, and further where said first edge sections 515 are arranged by conductive members 517 positioned on said dielectric member 303, and said second edge section 515 is arranged by conductive members 517 positioned on said dielectric member 303. In the example of FIG. 3d, the two opposing currents 619′ and 619″ of the differential current pair 619 are presented. The fold 304 of the dielectric member 303 may be arranged in the vicinity of the space divider 90, or in connection with the space divider 90.

FIG. 3e shows another example in accordance with an embodiment, of a cross section of the resonator 632, where said resonator 632 is arranged with the dielectric member 303, and said resonator 632 is formed by the conductive member 517 where the resonant gap 637 is arranged by the resonator 632, where said resonator 632 comprises the electrically non-conductive region 518 between edges of conductive members 517, where said non-conductive region 518 comprises a first edge section 515′ and a second edge section 515″, where said first edge section 515′ is arranged by the conductive member 517 positioned on said dielectric member 303, and said second edge section 515″ is arranged by an electrically conductive layer of the space divider 90.

According to an embodiment, the return path 516 may be arranged at the first frequency range between the conductive member 517 of the resonator 632 and a conductive layer 91 of the space divider 90.

In the example of FIG. 3e, there is provided an arrangement where an electrically conductive structural member 523 is adapted to be installed into a discontinuity region 101 of the space divider. In said arrangement, the surface of said electrically conductive structural member 523 defines a signal propagation direction for said communication channels 630, 631 from the first side 80 of the space divider 90 to the second side 81 of the space divider 90.

In the embodiment presented in FIG. 3e, the return path 516 at the first frequency range comprises a section of the electrically conductive structural member 523, where the resonator 632 is coupled to said conductive member 523. Said coupling may be arranged at least by the electric fields 617.

In an embodiment of the present disclosure, at least a part of said group of radiators 502 may be arranged to couple inductively, capacitively, or galvanically to a conductive structural member 523 of the space divider 90 in an arrangement where said conductive structural member 523 acts as a current return path for said coupled radiators 502 at the first frequency range. With said arrangement, there is a benefit of reducing the material required to build up the dual polarized repeater 500, when a part of the existing space divider 90 may be utilized as a part of the device 501. Another benefit is that the physical space required for the resonators may be reduced.

FIG. 3f shows another example of the resonator 632 of the repeater 500. According to an embodiment, the dual polarized repeater 500 comprises at least two isolated connections 638 and 639 to connect the incident signal 601′ to the first beam 803 and the second incident signal 601″ to the second beam 804 for providing the at least two discriminated communication channels 630 and 631 at a first frequency range. Further, in said arrangement, a coupling member 522 may be arranged at least partly inside the electrically non-conductive region 518 of the resonator 632 to enhance the coupling of the received electromagnetic energy of said first polarization component 611 from the first set of resonators 633 to the second set of resonators 634 to connect said first incident signal 601′ to said first beam 803. In an embodiment of the present disclosure, said coupling member 522 is capacitively coupled to the edge of the conductive member 517. In another embodiment of the present disclosure, said coupling member 522 is galvanically or inductively connected to the edge of the conductive member 517.

In accordance with an embodiment of the present disclosure, said dual polarized repeater 500 comprises a plurality of coupling members 522, where said coupling members 522 are arranged at least partly inside the electrically non-conductive regions 518 of said resonant gaps 637, and where said coupling members 522 are arranged to enhance the coupling of the received electromagnetic energy of said first polarization component 611 from the first set of resonators 633 to one of said at least two isolated connections 638, 639.

In accordance with an embodiment of the present disclosure, said coupling members 522 may comprise an open ended conductive member 517, where said open ended conductive members are arranged inside open or closed loops of conductive elements.

In accordance with an embodiment of the present disclosure, said coupling members 522 may comprise loops of conductive members 517, where said loops of conductive members 517 are arranged inside open or closed loops of conductive elements.

In accordance with an embodiment of the present disclosure, said coupling members 522 may comprise meandering patterns of conductive members 517, where said meandering patterns of conductive members 517 are arranged inside open or closed loops of conductive elements.

On the Second Polarization Component

The preceding sections described the reception of the first incident polarization component 611 by the first set of resonators 633 in a physically limited space at least in a first dimension. It is an aim of the present disclosure to provide a device that is capable of exploiting antenna beamforming from a narrow aperture in two crossing polarizations. In an advantageous embodiment of the present disclosure, the discontinuity region 101 of the space divider 90 comprises an opening that has a first dimension less than 10 cm, and a second dimension more than 60 cm.

In an advantageous embodiment, the discontinuity region 101 comprises an opening that has a first dimension less than 10 cm in the horizontal direction, and a second dimension more than 60 cm in the vertical direction, and said first incident polarization component 611 being predominantly vertical, and said second incident polarization component 612 being predominantly horizontal polarization.

In another advantageous embodiment, the discontinuity region 101 comprises an opening that has a first dimension less than 10 cm in the vertical direction, and a second dimension more than 60 cm in the horizontal direction, and said first incident polarization component 611 being predominantly horizontal, and said second incident polarization component 612 being predominantly vertical polarization.

In the following, there is provided an embodiment of the present disclosure that may be arranged for the reception of the second incident polarization component 612 by the device 501.

It is an aim of the aspects of the disclosed embodiments to provide a device with enhanced capabilities of receiving signals of two crossing polarizations at the first frequency range through a sub-wavelength passage in an arrangement, where the discrimination of said two crossing polarization components is maintained, and where said sub-wavelength passage is arranged in the discontinuity region 101 of the space divider 90.

In accordance with an embodiment of the present disclosure, said group of radiators 502 comprises the first set of resonators 633 and the second set of resonators 634, where said first set of resonators 633 are arranged to receive and discriminate signals of said first 611 and said second 612 incident polarization components at the first frequency range from the first side of the space divider, where said first 611 and second 612 incident polarization components are crossing polarizations.

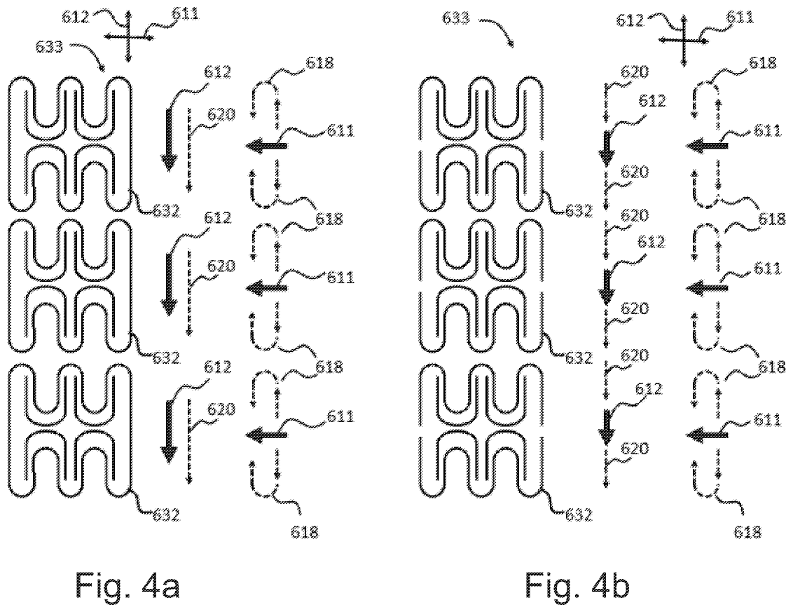

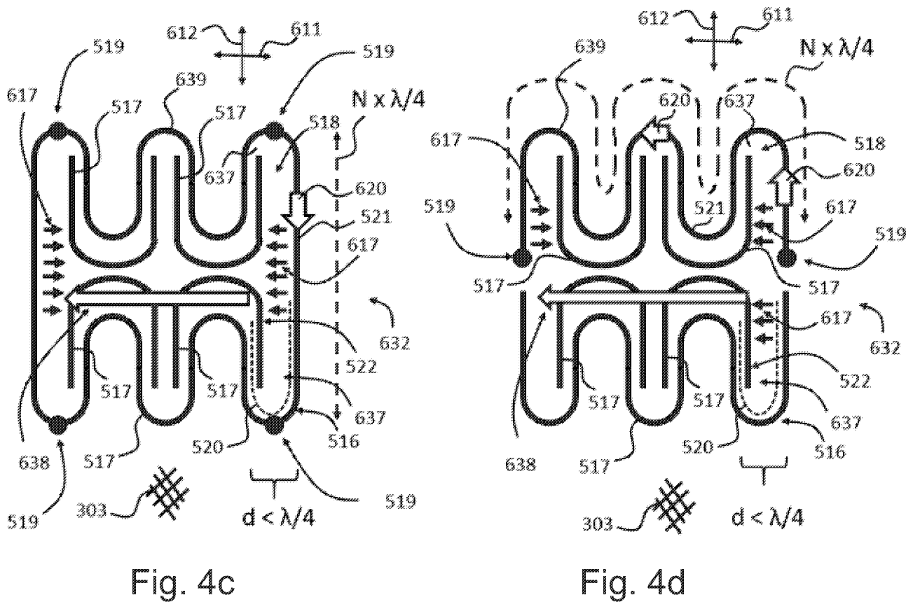

FIGS. 4a and 4b present the currents and electric fields in the resonators 632 shown in FIGS. 4c and 4d, in an arrangement where said resonators 632 are arranged as the first set of resonators 633 to receive said first 611 and said second 612 incident polarization components at the first frequency range.

FIGS. 4c and 4d show examples of resonators 632 that are arranged to operate at two crossing polarizations while maintaining the discrimination of the crossing polarization components.

In accordance with an embodiment of the present disclosure, the first set of resonators 633 may be arranged on a dielectric member 303, where said first set of resonators 633 is arranged to receive said first polarization component 611 by a plurality of resonant gaps 637 within conductive members 517, and said first set of resonators 633 is arranged to receive said second 612 incident polarization component by an array of resonant conductive members 517 comprising at least two high impedance nodes 519 and a low impedance path 521 between said high impedance nodes, where further in said arrangement, said first set of resonators 633 is adapted to receive said first 611 and second 612 incident polarization components from the first side 80 of the space divider 90 through an aperture, where said aperture has a first dimension less than a wavelength and a second dimension larger than two wavelengths at the first frequency range.

In the examples of FIGS. 4c and 4d, there is presented the conductive members 517 comprising at least two high impedance nodes 519 and a low impedance path 521 between said high impedance nodes. In FIG. 4c, said high impedance nodes 519 are arranged to receive the second incident polarization component 612 from the first side 80 of the space divider 90 by bending or meandering the conductive member 517 in an arrangement, where the circumference of the loop made out of the conductive member 517 corresponds to a resonant length, and the radiation and reception of said resonator is steered at least to the first side 80 of the space divider 90. In said arrangement, the high impedance nodes 519 and the low impedance path 521 are arranged to receive the signal component according to the second incident polarization component 612. Further in said arrangement, a current 620 is induced by the second incident polarization component 612 to awake the resonance of the resonator 632 at the first frequency range. It is an aim to have a low cross correlation between said current 620 and the current loop 618 that is received from the first incident polarization component 611 in order to provide the discrimination of said crossing polarization components.

In FIG. 4d, said high impedance nodes 519 are arranged by open ends of the conductive member 517 in an arrangement, where the path along the conductive member 517 between two separated high impedance nodes corresponds to a resonant length. Said resonant length is a multiple of a quarter of a wavelength at the first frequency range. In said arrangement, the high impedance nodes 519 and the low impedance path 521 are arranged to receive the signal component according to the second incident polarization component 612. Further in said arrangement, a current 620 is induced by the second incident polarization component 612 to awake the resonance of the resonator 632 at the first frequency range. It is an aim to have a low cross correlation between said current 620 and the current loop 618 that is received from the first incident polarization component 611 in order to provide the discrimination of said crossing polarization components.

In the examples of FIG. 4a-4d, the electric fields 617 are primarily induced by the first incident polarization component 611. The resonators 632 may be arranged to receive the second incident polarization component 612 by the same conductive member 517 in an arrangement, where the resonant modes, i.e. the standing wave patterns of the currents and electric fields of the discriminated signal components have weak cross correlation. Said arrangement may be obtained by utilizing multiple resonant modes of the same resonator 632 at the first frequency range.

In an embodiment of the present disclosure, the resonator 632 having at least two resonant modes at the first frequency range is arranged to receive the first incident polarization component 611 by a first resonant mode, wherein in said arrangement the reception of the first incident polarization component 611 by a second resonant mode is suppressed, and further the resonator 632 is arranged to receive the second incident polarization component 612 by a second resonant mode, wherein in said arrangement the reception of the second incident polarization component 612 by the first resonant mode is suppressed.

In accordance with an embodiment of the present disclosure, said second incident polarization component 612 may be received by at least two resonators 632 of the first set of resonators 633, where said at least two resonators 632 comprise at least two high impedance nodes 519 of the conductive member 517, and a low impedance path 521 arranged between said two high impedance nodes 519, where the distance between said high impedance nodes 519 defines a resonant length at the first frequency range along the edge of said conductive member 517, where said resonant length is a multiple of a quarter of a wavelength at the first frequency range.

FIGS. 4a and 4b show examples of the currents in the dual mode resonators, in accordance with an embodiment. In FIG. 4a, the first incident polarization component 611 awakes the first resonant mode that is primarily characterized by the current loops 618. An arrangement of said resonators in an array on the dielectric member 303 may be used to provide a constructive interference in the radiation pattern provided by the first set of resonators 632 in the first incident polarization component 611. In FIG. 4b, the first incident polarization component 611 awakes the first resonant mode that may be primarily characterized by the current loops 618. An arrangement of said resonators 632 in an array on the dielectric member 303 may be used to provide a constructive interference in the radiation pattern provided by the first set of resonators 633 in the polarization direction of the first incident polarization component 611.

In the examples of 4a and 4b, the constructive interference in the radiation patterns created by the resonators 632 of the first set of resonators 633 in two crossing polarizations 611 and 612 is pronounced.

In FIG. 4a, the second incident polarization component 612 awakes the second resonant mode that is primarily characterized by the currents 620 arranged between two high impedance nodes 519, where said currents 620 are arranged to flow along the low impedance paths 521. An arrangement of said resonators in an array on the dielectric member 303 may be used to provide a constructive interference in the radiation pattern provided by the first set of resonators 632 in the polarization direction of the second incident polarization component 612.

In FIG. 4b, the second incident polarization component 612 awakes the second resonant mode that is primarily characterized by the currents 620 arranged between two high impedance nodes 519, where said currents 620 are arranged to flow along the low impedance paths 521. An arrangement of said resonators in an array on the dielectric member 303 may be used to provide a constructive interference in the radiation pattern provided by the first set of resonators 632 in the polarization direction of the second incident polarization component 612.

There is provided an arrangement for two isolated connections 638, 639 in FIGS. 4c and 4d. In FIG. 4c, it is an aim of said connections 638 and 639 to enhance the coupling of the received electromagnetic energy through the space divider 90, and to enhance the transfer of the electromagnetic energy within the device 501 from the first end of the dual polarized repeater 500 to a second end of the dual polarized repeater 500, where said two ends are arranged to receive and radiate electromagnetic signals on opposite sides of the space divider 90. In an embodiment, said connections 638 and 639 may be arranged to transfer the discriminated signal components of the two crossing polarization components at the first frequency range from the first side 80 of the space divider 90 to the second side 81 of the space divider. In another embodiment, said connections 638 and 639 may be arranged to enhance the coupling of the discriminated signal components of the two crossing polarization components at the first frequency between two regions of the dual polarized repeater 500.

In an embodiment of the present disclosure, said isolated connections 638 and 639 may be provided by said dual mode resonators, where said isolation of the connections 638 and 639 is provided by a cross-mode suppression of the two resonant modes at the first frequency range within said dual mode resonator.

In an embodiment of the present disclosure, the first isolated connection 638 may be provided by the coupling members 522, as presented in the examples of FIGS. 4c and 4d.

In an embodiment of the present disclosure, the second isolated connection 639 may be provided by a conduction current along the conductive member 517 of the resonator 632, where said conduction current may be induced by the resonant current 620, as presented in the examples of FIGS. 4c and 4d.

In an embodiment of the present disclosure, said isolated connections 638 and 639 comprise a set of transmission lines.

In an embodiment of the present disclosure, said isolated connections 638 and 639 comprise a set of electromagnetically coupled resonators 632.

In an embodiment of the present disclosure, said isolated connections 638 and 639 comprise a thermal break to reduce heat transfer in the direction of the repeated electromagnetic signal. Said thermal break may comprise a meandering pattern or an inductive section of a conductive member, or it may comprise a section where the isolated connections 638 and 639 are implemented by means of electromagnetic coupling without a galvanic connection.

In an embodiment of the present disclosure, said at least two isolated connections are arranged at least partly by means of electric field coupling or magnetic field coupling.

In an embodiment of the present disclosure, said at least one of the two isolated connections comprises a waveguide, a transmission line, or a thermal break.

In accordance with an embodiment of the present disclosure, the dual polarized repeater 500 may comprise at least two isolated connections (638, 639) arranged to connect said first incident signal 601′ to said first beam 803 and said second incident signal 601″ to said second beam 804 for providing said at least two discriminated communication channels (630, 631) at the first frequency range in an arrangement, where said at least two isolated connections (638, 639) are arranged on the dielectric member 303, and further where the surface of said dielectric member 303 defines a signal propagation direction for said communication channels (630, 631) from the first side 80 of the space divider 90 to the second side 81 of the space divider 90.

In an embodiment of the present disclosure, said thermal break is arranged to reduce heat transfer in the direction of said signal propagation direction for said communication channels 630, 631 from the first side 80 of the space divider 90 to the second side 81 of the space divider 90, or vice versa.

In accordance with an embodiment of the present disclosure, the dual polarized repeater 500 may comprise at least two isolated connections 638, 639 to connect said first incident signal 601′ to said first beam 803 and said second incident signal 601″ to said second beam 804 for providing said at least two discriminated communication channels (630, 631) at a first frequency range in an arrangement, where the at least two isolated connections (638, 639) are arranged by at least two isolated transmission lines.

In accordance with an embodiment of the present disclosure, said arrangement for at least two isolated connections may comprise a first set of conductive members 517 to form the first communication channel 630 and a second set of conductive members 517 to form the second communication channel 631, wherein said arrangement, the first set of conductive members 517 is arranged to form the first communication channel 630 along a path from the first set of resonators 633 to the second set of resonators 634 to guide the received electromagnetic energy of the electromagnetic signal carried by said first polarization component 611 at the first frequency range, wherein said signal is transferred by a differential mode current within said set of conductive members 517. Further in said arrangement, the second set of conductive members 517 may be arranged to form the second communication channel 631 along a path from the first set of resonators 633 to the second set of resonators 634 to guide the received electromagnetic energy of the electromagnetic signals carried by said second polarization component 612 at the first frequency range, where said first communication channel 630 and said second communication channel 631 are arranged to form the discriminated communication channels to preserve separation of the first and second received polarization component of the electromagnetic signal, wherein said arrangement, any of said first or second communication channels is arranged to bypass said space divider 90 via said discontinuity region 101.

A Device Having a Filter

The device according to the present disclosure may utilize a combination of various filters to enhance the performance. A band stop filter may be used to filter out unwanted frequencies. On the other hand, filtering may be provided by using an apparatus which combines two or more signal components having a phase. An example of such apparatus is, for example, a branch line coupler, a rat race, or another commonly known component in high frequency electronics.

In an embodiment of the present disclosure, there is provided a band stop filter to suppress the propagation of a signal component from the first side 80 of the space divider 90 to the second side 81 of the space divider 90.

It may be advantageous to suppress the propagation of certain signal components to reduce noise and interference, or to provide a security feature by isolating the signal environment. An example of such isolated signal environment is the suppression of a WIFI signal, while repeating other wireless signals through the space divider. Such band stop filter may be arranged to suppress any polarization component, and it can also be arranged to suppress multiple crossing polarization components.

In an embodiment, the device 501 comprises at least one band stop filter that is arranged to suppress the propagation of a signal component at a frequency that is different from the frequency of the first 601′ or the second 601″ incident signal.

In an embodiment, said band stop filter is arranged on said dielectric member 303.

In an embodiment, said band stop filter is a resonant structure that is arranged to provide a high propagation impedance for the filtered signal at a resonant frequency of the band stop filter.

In an embodiment of the present disclosure, there is provided a coupler, where said coupler being connected to the first set of resonators 633 and/or to the second set of resonators 634, where said coupler being arranged to provide isolation for the at least two discriminated communication channels (630, 631) at a first frequency range.

In an embodiment of the present disclosure, there is provided a coupler, where said coupler being connected to a dual mode resonator, said dual mode resonator belonging to the first set of resonators 633 and/or to the second set of resonators 634, where said coupler being arranged to provide isolation for signals received or radiated in two crossing polarization at the first frequency range.

In an embodiment, said coupler is a branch line coupler.

On the Conductive Structural Member

A cavity closer is a structural element that may be used in connection with construction supplies such as window or door frames. A traditional use of a cavity closer is to enhance the thermal insulation properties of a wall having a discontinuity region, for example, next to a window or a door. It may also provide a mechanical support to attach the construction supply with screws, urethane foam, or other well-known method. An aim of a cavity closer may also be the reduction of air leakage through heterogeneous wall structures in the locations of the discontinuity regions.

A structural element, such as a cavity closer, may comprise an electrically conductive structural member. Said electrically conductive structural member may also comprise a thermal break, which may be implemented in a form of slots or grooves.

In accordance with an embodiment of the present disclosure, said dual polarized repeater 500 may comprise an electrically conductive structural member, where said electrically conductive structural member is adapted to be installed into a discontinuity region 101 of the space divider 90, where at least a part of the elements of said first set of resonators 633 or said second set of resonators 634 may be arranged as slots or grooves in said electrically conductive structural member, and further, where the surface of said electrically conductive structural member defines a signal propagation direction for said communication channels 630, 631 from the first side 80 of the space divider 90 to the second side 81 of the space divider 90.

In another embodiment of the present disclosure, said electrically conductive structural member may comprise a group of slots or grooves arranged as a thermal break, where said thermal break reduces the heat transfer in the direction of said signal propagation direction.

Application Areas

In the following, few examples of application areas are described.

Retrofit Antenna

One aspect of the present disclosure is that the device can be installed afterwards in already existing buildings or similar places where a space divider 90 is attenuating wireless signals. In an arrangement, said space divider may comprise a window having a plurality of glass panes 301, where at least one of said glass panes 301 comprises an electrically conductive layer 91

In an embodiment, the device 501 of the present disclosure may be adapted to be retrofitted in connection with a construction supply.

In an embodiment, the device 501 of the present disclosure may be adapted to be retrofitted in connection with a wall of an isolated space.

In an embodiment, the device 501 of the present disclosure is arranged as a pathway for a fixed wireless access signal. In said arrangement, the signal of separate multipath propagation channels may be redirected to indoor wireless terminals. In another embodiment, the device may be arranged to provide the signal of external base stations to a fixed wireless access router, where said router is arranged to couple to the device of the present disclosure.

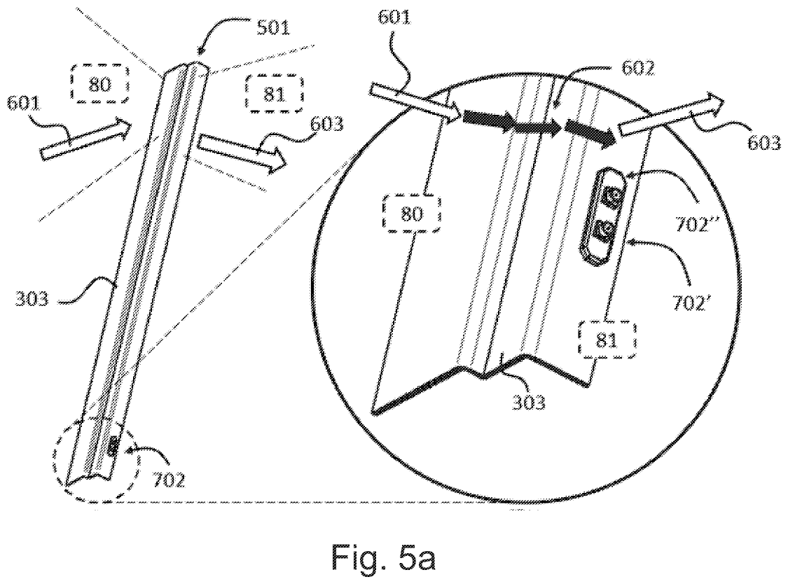

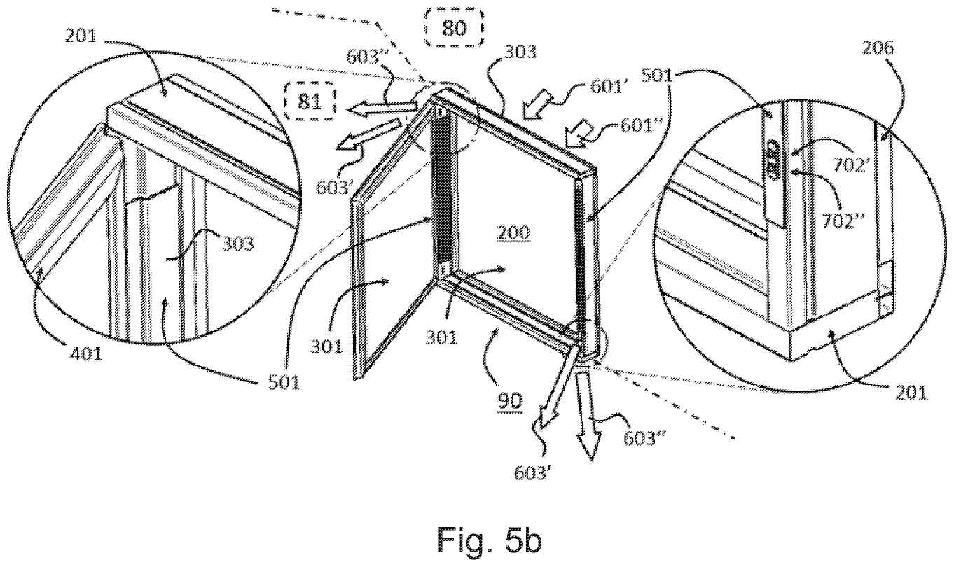

In FIG. 5a, there is provided an example of a retro-fitted device 501, in accordance with an embodiment. The device 501 comprises the dual polarized repeater 500 (not visible in FIG. 5a), and an antenna connection 702. Said antenna connection 702 may be arranged to connect external radio transceivers with the device 501. In an embodiment, said antenna connection 702 may be arranged to provide a connection for MIMO or diversity channels. In said arrangement, there may be at least two connections, where said at least two connections comprise a first connection 702′ for the first channel and a second connection 702″ for the second channel at the first frequency range.

In an embodiment of the present disclosure, the polarized repeater 500 may be arranged to be permanently or temporarily coupled with an external radio transceiver or transmission line via the antenna connector 702, where said antenna connector may be attached to the device 501 by means of any of a galvanic contact such as soldering or a contact spring, contactless electromagnetic coupling, a sticker, a magnet, a snap-on fastener, a so-called hook-and-loop fastener (e.g. Velcro™) or glue, or lamination.

In an embodiment, the device 501 of the present disclosure is arranged as a pathway for a fixed wireless access signal, where said device 501 is adapted to be retro-fitted in a discontinuity region 101 of the space divider 90.

In the example shown in FIG. 5b, there is provided an energy saving window assembly 200 having at least a frame 201, which may comprise any conductive or non-conductive material, and a plurality of glass panes 301 comprising one or more conductive layers. In an embodiment, the device 501 may be installed between the frame 200 and a sash 401 of said window assembly 200.

FIG. 5b shows an example of the device 501 adapted to be retro-fitted in the discontinuity region 101. There is provided an embodiment, where the device 501 is adapted to be attached in connection with a construction supply. In the embodiment presented in FIG. 5b, said construction supply is a window unit.

In an embodiment, said dielectric member 303 may be a rigid plastic, where said rigid plastic may have predefined profile.

In an embodiment, said dielectric member 303 may be a flexible plastic, where said flexible plastic may have an adjustable profile according to the installation surface.

It is obvious that the device 501 may be attached to a construction supply using any possible attachment methods.

A Window Unit Comprising the Device

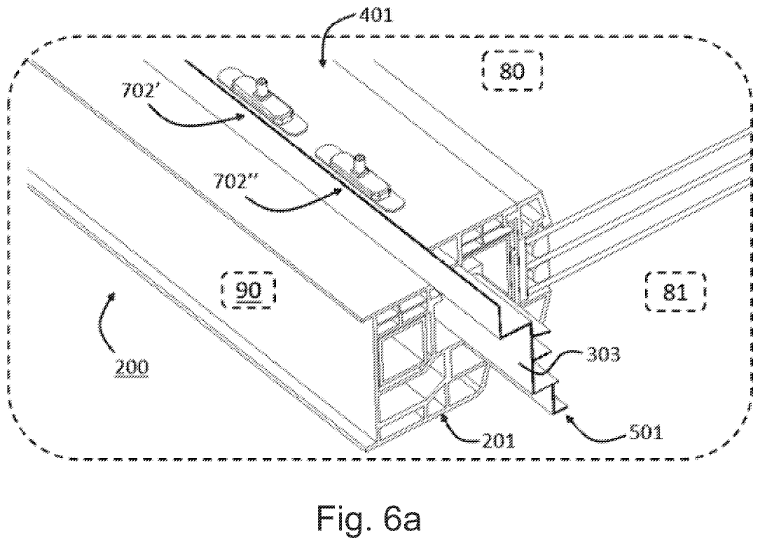

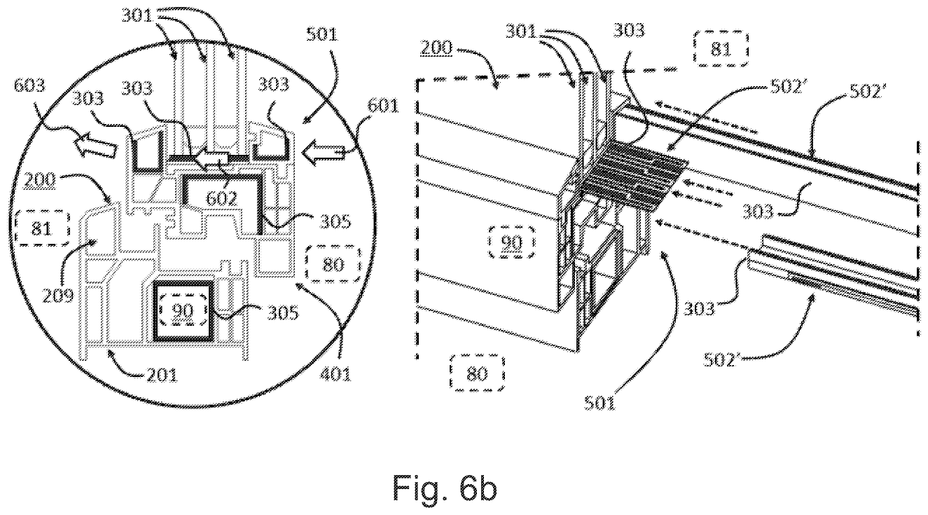

FIGS. 6a-6b present examples of an embodiment, where the device 501 is integrated in connection with a window unit.

In an embodiment, the space divider 90 may comprise a construction supply. In another embodiment, said construction supply comprises the energy efficient window unit 200, wherein said arrangement, the dual polarized repeater 500 of the device 501 is arranged at least partly on the dielectric member 303.

In FIG. 6a, there is provided an example of the device 501 in connection with the energy efficient window unit 200, where the device 501 comprises the dual polarized repeater 500, and an antenna connection 702 that may be arranged to connect external radio transceivers with the device 501.

In an embodiment, said antenna connection 702 may be arranged to provide a connection for MIMO or diversity channels through the dual polarized repeater 500 in an arrangement, where said antenna connection is integrated with a part of the energy efficient window assembly 200. In an embodiment, there may be at least two connections, where said at least two connections comprise a first connection 702′ for the first channel and a second connection 702″ for the second channel 702″ at the first frequency range.

In an embodiment, said dielectric member 303 may comprise at least a rigid bar or profile, where said rigid bar or profile is adapted to be assembled with a part of the energy efficient window unit 200.

There is provided an embodiment, where said dielectric member 303 is arranged as a profile, where the shape of said profile is arranged to conform with at least one part of the energy efficient window unit 200. In the example of FIG. 6a, said profile is arranged to conform with at least an edge of a sash 401. In the example of FIG. 6b, said profile is arranged to conform with an insulation cavity 209 of the window frame 201 of sash 401.

In another embodiment, there is provided the dielectric member 303, where said dielectric member 303 is arranged as a deformable profile, where the shape of said deformable profile is arranged to be conformable with at least one part of the energy efficient window unit 200. In an embodiment, said dielectric member is a tape. In another arrangement, said dielectric member 303 comprises a plurality of dielectric layers, where at least one of said layers comprises an adhesive layer, and at least one of said layers comprises a plastic layer.

In another embodiment, there is provided the dielectric member 303, where said dielectric member 303 is arranged as an expandable and deformable profile, where the shape of said expandable and deformable profile is arranged to be conformable with at least one part of the space divider 90.

In an embodiment, said dielectric member 303 has a form of a tape, where said tape comprises a conductive layer arranged on said dielectric member 303, where the group of radiators 502 is arranged on said conductive layer as grooves or slots.

In an a embodiment, said dielectric member 303 has a form of a tape, where said tape comprises a plurality of conductive members 517 arranged on said dielectric member 303, where the group of radiators 502 is arranged by said plurality of conductive members 517.

In an a embodiment, said dielectric member 303 comprises at least an expandable foam tape.

In an a embodiment, said dielectric member 303 comprises at least an expandable foam tape, where said expandable foam tape is arranged to attach the dual polarized repeater 500 in connection with a part of the space divider 90.

In an a embodiment, said dielectric member 303 comprises at least an expandable foam tape, where said expandable foam tape is arranged to attach the dual polarized repeater 500 in connection with a construction supply.

In an embodiment, the profile of said dielectric member 303 may be arranged according to the shape of a part of a window, such as PVC part, fiberglass part, or a metal part of the window. It is often the case that insulation cavities 209 are used in window parts in order to enhance the energy efficiency of the low energy window assembly 200. In said cases, it may be advantageous to provide pre-manufactured profiles or bars that comprise the embodiments of the dual polarized repeater 500, and where said bars are shaped according to a part of the window or other construction supply. Said bars may then be factory installed in connection with the construction supply in a cost efficient way. Said bars may be arranged to slide into the insulation cavities 209. Said profiles may also comprise an adhesive layer, which allows the profile to be attached with the construction supply.

In an embodiment, said dielectric member 303 may be a mechanical stiffening profile 305, where said stiffening profile is arranged to be inserted in a window frame.

In accordance with an embodiment, there is provided a method for manufacturing a device 501 for repeating wireless electromagnetic signals from a first side 80 of a space divider 90 to a second side 81 of a space divider 90, the device 501 being adapted to provide at least two discriminated communication channels 630, 631 at a first frequency range between the two spaces separated by the space divider 90, characterized in that the method comprises at least installation of a dielectric member 303, said dielectric member 300 comprising a dual polarized repeater 500, in connection with the space divider 90, where said space divider comprises at least a construction supply, where said dielectric member 303 comprises at least a profile, where said profile is arranged to conform with at least one surface of said construction supply.

In the embodiment shown in FIG. 6b, the group of radiators 502 may be arranged with a plurality of dielectric members 303, where separate members 502′ of the group of radiators 502 may be arranged on separate dielectric members 303, wherein said arrangement the electromagnetic connection between separated members 502′ is maintained.

In accordance with an embodiment, there is provided a method for manufacturing a device 501 for repeating wireless electromagnetic signals from a first side 80 of a space divider 90 to a second side 81 of a space divider 90, the device 501 is adapted to provide at least two discriminated communication channels 630, 631 at a first frequency range between the two spaces separated by the space divider 90, characterized in that the method comprises at least installation of a dielectric member 303, said dielectric member 300 comprising a dual polarized repeater 500 in connection with the space divider 90, where said space divider comprises at least a construction supply, where said dielectric member 303 comprises at least a profile, where said profile is arranged to conform with at least one surface of said construction supply, where said dielectric member 303 comprises at least a profile, where said profile is arranged to conform with at least one surface of said construction supply, where said construction supply comprises at least a window frame 201, sash 401, a wall 100, or a glass pane having an electrically conductive surface 301

An Embodiment of the Device Having an Insulating Member

In accordance with an embodiment of the present disclosure, there is provided a dual polarized repeater 500 of said device 501, said dual polarized repeater 500 comprising a dielectric member 303, and a set of conductive members 517 is arranged as a group of radiators 502 to form said dual polarized repeater 500, where said dielectric member 303 is arranged on an insulation panel, said insulation panel having a density less than 500 kg/m3. The insulation panel may be rigid or flexible.

In accordance with an embodiment of the present disclosure, there is provided a dual polarized repeater 500 of said device 501, said dual polarized repeater 500 comprising a dielectric member 303, and a set of conductive members 517 is arranged as a group of radiators 502 to form said dual polarized repeater 500, where said dielectric member 303 is an insulation panel, said insulation panel having a density less than 500 kg/m3. The insulation panel may be rigid or flexible.

In an embodiment, the space divider 90 is a wall element, where said device 500 is integrated with said wall element.

In an embodiment, the space divider 90 is a concrete wall element, where said device 500 is cast into said concrete wall element.

In an embodiment, the space divider 90 is a concrete wall, where said device 500 is cast into said concrete wall.

An Arrangement Having a Multi-Mode Resonator

In a preferred embodiment of the present disclosure, the device 501 is adapted to be installed into a sub-wavelength passage in the space divider 90, where said sub-wavelength passage is provided by a discontinuity region 101 having at least a first dimension 901 smaller than a wavelength at a first frequency range. Said sub-wavelength passage may be provided by an aperture in the space divider 90.

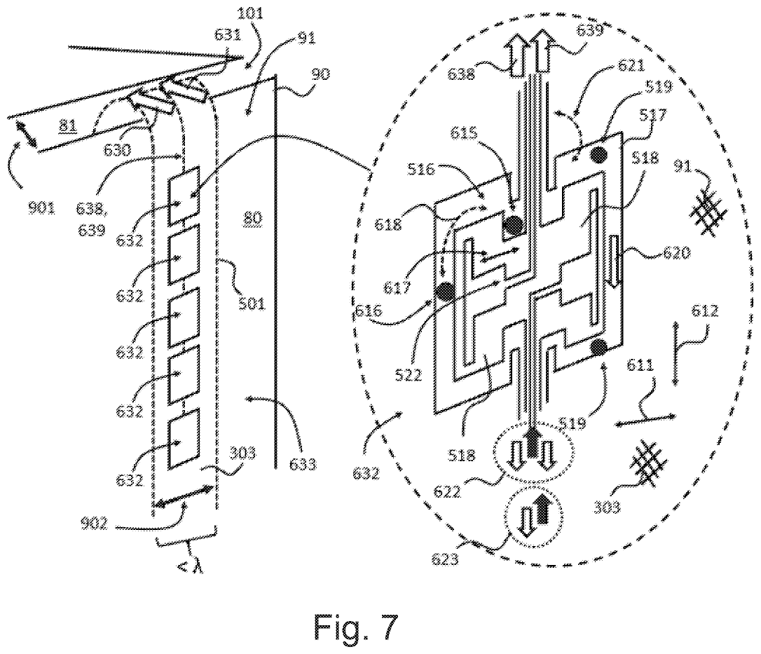

In FIG. 7, there is provided an example of the device 501, in accordance with an embodiment. There is provided an arrangement with the discontinuity region 101, said discontinuity region having an aperture with a first dimension 901 less than a wavelength at the first frequency range.

In an embodiment, the space divider 90 is a door, or a window, or a part of a shipping container, or a reefer.

In an embodiment, the first set of resonators 633 may be arranged on the dielectric member 303, and in said arrangement the first set of resonators 633 is arranged as an array, said array having at least a first dimension 902 of less than a wavelength at the first frequency range.

There is provided an arrangement of resonators 632, where said resonators 632 are arranged for multimode resonance at the first frequency range.

In an embodiment, said group of radiators 502 may comprise a resonator 632, where said resonator 632 comprises at least a first resonant mode, and a second resonant mode at the first frequency range, where said first resonant mode is arranged to receive said first incident polarization component 611, and said second resonant mode is arranged to receive said second incident polarization component 612.

In an embodiment, said group of radiators 502 may comprise a resonator 632, where said resonator 632 comprises at least a first resonant mode, and a second resonant mode at the first frequency range, where said first resonant mode is arranged to form said first beam 803, and said second resonant mode is arranged to form said second beam 804.

In an embodiment, said dual mode resonance of said resonator 632 may be arranged with a first resonance mode having a first resonant current, and with a second resonant mode having a second resonant current, wherein said first and second resonant currents are arranged to oscillate in two crossing directions.

In an embodiment, there is a group of resonators 632 arranged on the dielectric member 303. Said dielectric member 303 may comprise a plurality of dielectric layers, wherein of said plurality of dielectric layers at least one layer comprises the first set of resonators 633.

In an embodiment, there is a group of resonators 632 arranged on the dielectric member 303. Said dielectric member 303 may comprise a plurality of dielectric layers, wherein of said plurality of dielectric layers at least one layer comprises the second set of resonators 634.

In an embodiment, there is provided the first isolated connection 638 arranged on the dielectric member 303. Said dielectric member 303 may comprise a plurality of dielectric layers, wherein of said plurality of dielectric layers at least a first layer comprises the first isolated connection 638, and a second layer comprises the resonator 632.

In an embodiment, there is provided the second isolated connection 639 arranged on the dielectric member 303. Said dielectric member 303 may comprise a plurality of dielectric layers, wherein of said plurality of dielectric layers at least a first layer comprises the second isolated connection 639, and a second layer comprises the resonator 632.

In an embodiment, the surface of the dielectric member 303 defines a signal propagation direction for said communication channels 630, 631 from the first side 80 of the space divider 90 to the second side 81 of the space divider 90.

In an embodiment, said signal propagation is defined along a path that follows the direction of a tangential component of the surface of the dielectric member 303.

In an embodiment, said signal propagation is defined along a path that follows the direction of a tangential component of the surface of the dielectric member 303, where said path follows a bend of the dielectric member 303 over the discontinuity region 101.

In FIG. 7, there is provided a space divider 90 having an electrically conductive surface 91. In said arrangement, the resonator 632 may be arranged to operate in connection with the conductive surface 91.

In an embodiment of the present disclosure, at least a part of said group of radiators 502 may be arranged to couple inductively, capacitively, or galvanically to an electrically conductive layer 91 of the space divider 90 in an arrangement where said electrically conductive layer 91 acts as a current return path for said coupled radiators 502 at the first frequency range.

In the embodiment shown in FIG. 7, there is presented the oscillating electric field 617, which is the electric field of the first resonant mode of said resonator 632, where said first resonant mode is arranged to receive the first incident polarization component 611. Furthermore, in said embodiment, there is a second oscillating electric field 621. Said second oscillating electric field 621 of the second resonant mode of said resonator 632 is arranged to receive the second incident polarization component 612. In the example of FIG. 7, said second oscillating electric field 621 is arranged between the resonator 632 and the conductive surface 91 of the space divider 90.

There is provided an arrangement for two isolated connections 638, 639 in FIG. 7. It is an aim of said isolated connections 638 and 639 to enhance the coupling of the received electromagnetic energy through the space divider 90, and to enhance the transfer of the electromagnetic energy within the device 501 from a first end of the dual polarized repeater 500 to a second end of the dual polarized repeater 500, where said two ends are arranged to receive and radiate electromagnetic signals on opposite sides of the space divider 90.

In an embodiment, said isolated connections 638 and 639 may be arranged to transfer the discriminated signal components of the two crossing polarization components at the first frequency range from the first side 80 of the space divider 90 to the second side 81 of the space divider in an arrangement, where said isolated connections 638 and 639 connect the first set of resonators 633 to the second set of resonators 634.

In an embodiment of the present disclosure, said isolated connections 638 and 639 may be coupled to dual mode resonators, where said isolation of the isolated connections 638 and 639 is enhanced by a cross-mode suppression of the two resonant modes of said dual mode resonators.

In an embodiment of the present disclosure, said isolated connections 638 and 639 may comprise a set of transmission lines.

In an embodiment of the present disclosure, said isolated connections 638 and 639 may comprise a set of transmission lines that are isolated by a substantially differing transmission line impedances, where said substantially differing transmission line impedances being individually matched to the first set of resonators 633 and/or to the second set of resonators 634.

In an embodiment of the present disclosure, said isolated connections 638 and 639 may comprise a set of transmission lines, where said transmission lines are arranged to provide isolation of said at least two discriminated communication channels 630 and 631 in an arrangement where said transmission lines are arranged to isolate the current modes 622 and 623 of the two channels 630 and 631, where the first current mode 622 carries the first communication channel 630, and the second current mode 623 carries the second communication channel 631.

In an embodiment, the current modes 622 and 623 of the isolated connections 638 and 639 may be discriminated by physically separated transmission lines.

In an embodiment, the current modes 622 and 623 of the isolated connections 638 and 639 may be discriminated by transmission lines, which comprise at least a ground member between said isolated connections 638 and 639.

In an embodiment, the first current modes 622 and 623 of the isolated connections 638 and 639 may be discriminated by transmission lines, wherein said transmission lines, the first current mode 622 is arranged to flow in two different opposite directions predominantly within conductive members 517 arranged on the dielectric member 303, and where the return current of the second current mode 623 is arranged to flow predominantly in the conductive surface 91 of the space divider 90.

In an embodiment, the current modes 622 and 623 of the isolated connections 638 and 639 may be discriminated by transmission lines, comprising short circuits, filters or resonators between said isolated connections 638 and 639.

In an embodiment of the present disclosure, said at least two isolated connections 638 and 639 may be arranged to couple to the first set of resonators 633 or to the second set of resonators 634 at least partly by means of electric field coupling or magnetic field coupling.

In accordance with an embodiment of the present disclosure, the dual polarized repeater 500 may comprise at least two isolated connections 638, 639 arranged to connect said first incident signal 601′ to said first beam 803 and said second incident signal 601″ to said second beam 804 for providing said at least two discriminated communication channels 630, 631 at the first frequency range in an arrangement, where said at least two isolated connections 638, 639 are arranged on the dielectric member 303, and further where the surface of said dielectric member 303 defines a signal propagation direction for said communication channels 630, 631 from the first side 80 of the space divider 90 to the second side 81 of the space divider 90, and said at least two isolated connections 638, 639 are arranged to discriminate the signals of the at least two discriminated communication channels 630, 631.

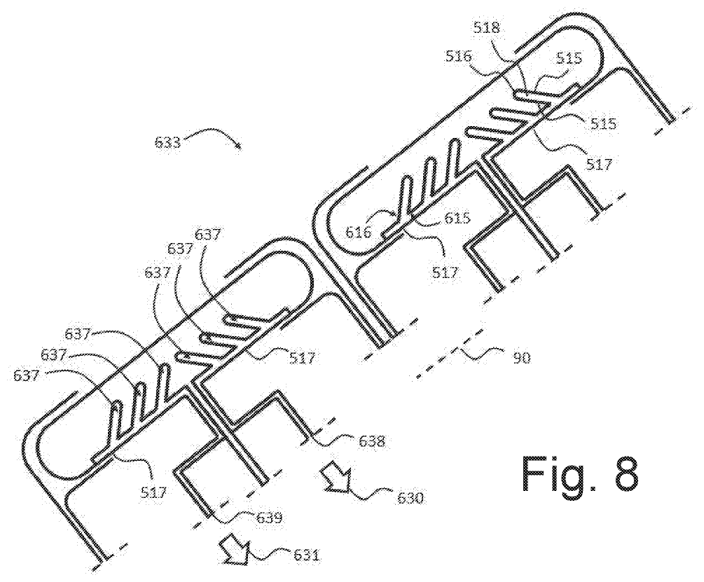

In FIG. 8, there is provided an example of the first set of resonators 633, in accordance with an embodiment.

In an advantageous embodiment of the present disclosure, the group of radiators 502 comprises a first set of resonators 633 to receive and discriminate signals of said first 611 and the second 612 incident polarization components at the first frequency range from the first side 80 of the space divider 90, where said first 611 and second 612 incident polarization components are crossing polarizations, and where said first set of resonators 633 is arranged to receive said first polarization component 611 by a plurality of resonant gaps 637 arranged within the set of conductive members 517, wherein said set of conductive members 517 being arranged to operate as an antenna at an external frequency range that is apart from the first frequency range.

In an embodiment of the present disclosure, said external frequency range is arranged below the first frequency range.

An Isolated Space Having a Node

The reading distance of RFID tags is directly proportional to the attenuation of the signal between a reader and a tag. Other factors may affect the distance as well, but a reduction of the propagation attenuation may have a significant effect on the operating distance. Furthermore, the orientation of the tag is usually unknown, and therefore using more than a single polarization for the wireless RFID link may be beneficial.

The utilization of RFID in shipping containers, reefers, and similar enclosed spaces may be challenging due to the attenuation of the enclosing walls.

In accordance with an example, there is provided a construction supply, a building, a cargo container, a reefer, a housing container, a railway carriage, a ship cabin, or a modular space comprising the device 501 for repeating wireless electromagnetic signals from a first side 80 of the space divider 90 to a second side 81 of a space divider 90, the device 501 being adapted to provide at least two discriminated communication channels 630, 631 at a first frequency range between the two spaces separated by the space divider 90, characterized in that the device 501 comprises the dual polarized repeater 500. And further, said dual polarized repeater 500 comprises a dielectric member 303, and a set of conductive members arranged as a group of radiators 502 to form said dual polarized repeater 500, where said dual polarized repeater 500 is adapted to be installed into a discontinuity region 101 of the space divider to create said at least two discriminated communication channels 630, 631 by providing an increment of the bistatic radar cross section (RCS) through said discontinuity region 101 for the first incident signal 601′ received at the first incident polarization component 611 and for the second incident signal 601″ received at the second incident polarization component 612, where at least a part of said first incident signal 601′ is scattered to the first beam 803, and at least a part of said second incident signal 601″ is scattered to the second beam 804 by said device 501, where said first 803 and said second 804 beams are arranged on the second side 81 of the space divider 90; and further where said dual polarized repeater 500 is adapted to provide cross polarization discrimination (XPD) for said first incident signal 601′ in said first beam 803, and said dual polarized repeater 500 is adapted to provide cross polarization discrimination (XPD) for said second incident signal 601″ in said second beam 804.

In accordance with an example, there is provided the dual polarized repeater 500 comprising at least the first set of resonators 633, said first set of resonators 633 being arranged to receive and discriminate signals of the first 611 and the second 612 incident polarization components at the first frequency range from the first side of the space divider, where said first 611 and second 612 incident polarization components are crossing polarizations, characterized in that at least one of said first 611 and second 612 incident polarization components is circular polarization.

In an embodiment, the first frequency range is arranged to cover at least one discrete frequency between 860-960 MHz.

In another embodiment, the first frequency range is arranged to cover at least one discrete frequency between 2.4-2.5 GHz.

Fixed Wireless Access

Fixed wireless access or fixed wireless broadband refer to a wireless alternative to a fixed cable or fiber in buildings. It is sometimes referred to as “final mile” connection. Fixed wireless broadband is especially feasible in modern mobile networks such as 4G/5G and beyond, because of the avoidance of physical cabling and agility of network implementation.

When a building has separate apartments or separate rooms, there is a benefit of using one or a plurality of the devices according to the present disclosure in window units or in connection with walls to enable physically fixed connection nodes and/or pathways for the signals of massive MIMO base stations. When the connection points are not physically moving over time, the time and resources needed for radiation pattern deforming may be reduced.

One benefit of the present disclosure is that it may simplify the operation of modern base stations in which multi user MIMO (MU-MIMO) is used. In MU-MIMO, the connections between the base stations and indoor user terminals may be multiplexed using the same frequency, where the service for separate users may be provided through separate beams of the base station. When the building wall is heavily attenuating the wireless signal, and when the devices according to the present disclosure are provided in the walls of separate apartments, there may emerge an optimal situation where the MU-MIMO beams of the base station for separate users are located at precisely fixed spots in the building wall. In an example having a multi-story building with concrete walls, the cells of separate users may be effectively separated utilizing the attenuation of the wall, and providing the connection through localized spots in the wall through the devices of the present disclosure.

In the case of a fixed wireless access, there is an advantage of utilizing the device according to the present disclosure in connection with auxiliary radio devices that may be coupled to the device 501.

In an embodiment of the present disclosure, said dual polarized repeater 500 is arranged to be coupled permanently or temporarily with an external radio transceiver or a transmission line by means of any of a galvanic contact such as soldering or a contact spring, contactless electromagnetic coupling, a sticker, a magnet, a snap-on fastener, a hook-and-loop fastener or glue, or lamination.

In a building with multiple rooms or apartments, the rooms or apartments can be divided into isolated cells, when the attenuation of the walls is utilized together with the device 501 to allow said cells to be connected to a base station.

In an embodiment of the present disclosure, there is a plurality of spatially divided cells, said cells operating at a first frequency range, and said cells are arranged within groups having at least three cells within a 200 m² area, where said at least three cells are separated by an attenuating medium to provide at least 15 dB isolation between adjacent spaces of said at least three cells, and further, where said at least three cells are connected to an external base station via a fixed wireless access (FWA) pathway, where said pathway comprises the device 501 according to the present disclosure.

Method of Using the Same

In accordance with an example, there is provided a method for operating a node over a wireless communication link, where said node is enclosed by a spatially isolated cell, said cell being enclosed at least partly by a space divider 90, and said wireless communication link is established from a first side 80 of the space divider 90 to a second side 81 of the space divider 90, characterized in that the method comprises at least repeating wireless electromagnetic signals from the first side 80 of said space divider 90 to the second side 81 of said space divider 90 using a device 501, the device 501 is adapted to provide at least two discriminated communication channels 630, 631 at a first frequency range between the two spaces separated by the space divider 90, where the device 501 comprises a dual polarized repeater 500, said dual polarized repeater 500 is adapted to be installed into a discontinuity region 101 of the space divider 90 to create said at least two discriminated communication channels 630, 631 by providing an increment of the bistatic radar cross section (RCS) through said discontinuity region 101 for a first incident signal 601′ received at a first incident polarization component 611 and for a second incident signal 601″ received at a second incident polarization component 612, where at least a part of said first incident signal 601′ is scattered to a first beam 803, and at least a part of said second incident signal 601″ is scattered to a second beam 804 by said device 501, where said first 803 and said second 804 beams are arranged on the second side 81 of the space divider 90, and further where said dual polarized repeater 500 is adapted to provide cross polarization discrimination (XPD) for said first incident signal 601′ in said first beam 803, and said dual polarized repeater 500 is adapted to provide cross polarization discrimination (XPD) for said second incident signal 601″ in said second beam 804.

In accordance with an embodiment of the method the node further comprises a RFID tag or a wireless sensor.

In accordance with an embodiment of the method, there is a plurality of said spatially divided cells comprising a node, where said nodes are operated by said wireless communication link, and said wireless communication link is adapted for a fixed wireless access (FWA), and further where each said cells are isolated by an attenuation of 10-70 dB between said cells at said first frequency range.

Some of the advantageous embodiments of the present disclosure are presented below.

In an embodiment, there is provided a device 501 for repeating wireless electromagnetic signals from a first side 80 of a space divider 90 to a second side 81 of the space divider 90, the device 501 being adapted to provide at least two discriminated communication channels (630, 631) at a first frequency range between two spaces separated by the space divider (90), characterized in that the device 501 comprises a dual polarized repeater 500 comprising a dielectric member 303, and a set of conductive members 517 arranged as a group of radiators 502 to form said dual polarized repeater 500, where said dual polarized repeater 500 is adapted to be installed into a discontinuity region 101 of the space divider 90 to create said at least two discriminated communication channels (630, 631) by providing an increment of a bistatic radar cross section through said discontinuity region 101 for a first incident signal 601′ received by the device 501 at a first incident polarization component 611 and for a second incident signal 601″ received by the device 501 at a second incident polarization component 612, where at least a part of said first incident signal 601′ is arranged to be scattered as a first beam 803 by said device 501, and at least a part of said second incident signal 601″ is arranged to be scattered as a second beam 804 by said device 501, where said first 803 and said second 804 beams are arranged on the second side 81 of the space divider 90; and said dual polarized repeater 500 is adapted to provide cross polarization discrimination for said first incident signal 601′ in said first beam 803; and said dual polarized repeater 500 is adapted to provide cross polarization discrimination for said second incident signal 601″ in said second beam 804.

In an embodiment, said dielectric member 303 is a multilayer laminate that comprises at least 3 layers.

In an embodiment, said dielectric member 303 comprises a heterogeneous stack of dielectric layers, where said heterogeneous stack comprises at least a first and a second dielectric layer, and an adhesive layer as a third dielectric layer between said first and second dielectric layer.

In an embodiment, said dielectric member 303 comprises a heterogeneous stack of dielectric layers, where said heterogeneous stack comprises at least a first dielectric layer, and an adhesive layer as a second dielectric layer between said first dielectric layer and an electrically conductive layer.

In an embodiment, said dielectric member 303 comprises at least one dielectric layer that is folded to form a stack of a multilayer stack, where at least two layers are connected from an edge by said fold.

In an embodiment, said group of radiators 502 comprises a first set of resonators 633 to receive and discriminate signals of said first 611 and the second 612 incident polarization components at the first frequency range from the first side 80 of the space divider 90, where said first 611 and second 612 incident polarization components are crossing polarizations, and where said first set of resonators 633 is arranged to receive said first polarization component 611 by a plurality of resonant gaps 637 arranged within the set of conductive members 517, and a second set of resonators 634 is arranged to form said first beam 803 and said second beam 804, wherein said first beam 803 has a polarization according to the first re-radiated polarization component 613; and said second beam 804 has a polarization according to the second re-radiated polarization component 614, where said first 613 and second 614 re-radiated polarization components are crossing polarizations.

In an embodiment, said plurality of resonant gaps 637 is arranged by resonators 632 comprising electrically non-conductive regions 518 between edges of said conductive members 517 where said non-conductive regions 518 comprise at least a first and a second edge section 515, and a return path 516 arranged between said first and said second edge sections 515, wherein said edge sections 515 and said return path 516 define a curve 520 where said curve 520 coils said non-conductive region 518 and the length of said curve is at least a quarter of a wavelength at the first frequency range and said return path 516 comprises a low impedance path or a displacement current between charge nodes, and further where said resonant gaps 637 are arranged to induce a positive charge distribution 615, and a negative charge distribution 616 along said curve 520 by the received electromagnetic energy of said first incident polarization component 611, wherein said positive 615 and negative 616 charge distributions are separated by a distance of larger than a quarter of a wavelength at the first frequency range along said curve 520, and where the shortest distance between said positive charge distribution 615, and said negative charge distribution 616 is arranged to be less than a quarter of a wavelength at the first frequency range, where said positive 615 and said negative 616 charge distributions are arranged to generate a potential difference between said first and said second edge section 515 within said non-conductive region 518, and a current loop 618 oscillating at the first frequency range between two nodes defined by said positive 615 and said negative 616 charge distributions, where said oscillating current loop 618 flows along said curve 520.

In an embodiment, said return paths 516 are arranged at the first frequency range as a galvanic contact, lumped or distributed capacitive component, lumped or distributed inductive component, active semiconductor component, low pass filter, high pass filter, or band pass filter.

In an embodiment, said plurality of resonant gaps 637 are arranged by resonators 632, where said resonators 632 comprise electrically non-conductive regions 518 between edges of conductive members 517 where said non-conductive regions 518 comprise at least first and second edge sections 515 of conductive members 517, and a fold 304 of said dielectric member 303 between said first and said second edge sections 515, wherein said first and second edge sections 515 and said fold 304 of said dielectric member 303 define a part of a curve 520, where said curve 520 coils said non-conductive region 518 and the length of said curve is at least a quarter of a wavelength at the first frequency range and said resonant gaps 637 are arranged to induce a positive charge distribution 615, and a negative charge distribution 616 along said curve 520 by the received electromagnetic energy of said first incident polarization component 611, wherein said positive 615 and negative 616 charge distributions are separated by a distance of less than a quarter of a wavelength at the first frequency range, where said positive 615 and said negative 616 charge distributions are arranged to generate a potential difference between said first and said second edge section 515 within said non-conductive region 518, and a differential current pair 619 oscillating along said first and said second edge sections 515, and further where said first edge sections 515 are arranged by conductive members 517 positioned on said dielectric member 303, and said second edge sections 515 are arranged either by conductive members 517 positioned on said dielectric member 303 or an electrically conductive surface of said space divider 90.

In an embodiment, said second incident polarization component 612 is arranged to be received by at least two resonators 632 of the first set of resonators 633, where said at least two resonators 632 comprise at least two high impedance nodes 519 of a conductive member 517, and a low impedance path 521 arranged between said two high impedance nodes 519, where the distance between said high impedance nodes 519 defines a resonant length at the first frequency range along the edge of said conductive member 517, where said resonant length is a multiple of a quarter of a wavelength at the first frequency range.

In an embodiment, said dual polarized repeater 500 comprises at least two isolated connections (638, 639) arranged to connect said first incident signal 601′ to said first beam 803 and said second incident signal 601″ to said second beam 804 for providing said at least two discriminated communication channels (630, 631) at a first frequency range in an arrangement, where said at least two isolated connections (638, 639) are arranged on said dielectric member 303, and further where the surface of said dielectric member 303 defines a signal propagation direction for said communication channels (630, 631) from the first side 80 of the space divider 90 to the second side 81 of the space divider 90.

In an embodiment, said dual polarized repeater 500 comprises at least two isolated connections (638, 639) to connect said first incident signal 601′ to said first beam 803 and said second incident signal 601″ to said second beam 804 for providing said at least two discriminated communication channels (630, 631) at a first frequency range in an arrangement, where the at least two isolated connections (638, 639) are arranged by at least two isolated transmission lines.

In an embodiment, said arrangement for at least two isolated connections comprises a first set of conductive members 517 to form the first communication channel 630 along a path from the first set of resonators 633 to the second set of resonators 634 to guide the received electromagnetic energy of the electromagnetic signal carried by said first polarization component 611 at the first frequency range, wherein said signal is transferred by a differential mode current within said set of conductive members 635, and a second set of conductive members 517 to form the second communication channel 631 along a path from the first set of resonators 633 to the second set of resonators 634 to guide the received electromagnetic energy of the electromagnetic signals carried by said second polarization component 612 at the first frequency range, where said first communication channel 630 and said second communication channel 631 are arranged to form the discriminated communication channels to preserve separation of the first and second received polarization component of the electromagnetic signal, and any of said first or second communication channels is arranged to bypass said space divider 90 via said discontinuity region 101.

In an embodiment, said dual polarized repeater 500 is arranged to create said at least two discriminated communication channels (630, 631) with an arrangement of said first beam 803 and said second beam, where said increment of the bistatic radar cross section is at least 3 dB and said cross polarization discrimination is at least 6 dB within said first beam 803 at the first frequency range, and said increment of the bistatic radar cross section is at least 3 dB and said cross polarization discrimination is at least 6 dB within said second beam (804) at the first frequency range.

In an embodiment, said dual polarized repeater 500 is arranged to create said at least two discriminated communication channels (630, 631) with an arrangement of said first beam 803 and said second beam 804, where the envelope correlation coefficient for the first incident signal 601′ and the second incident signal 601″ in said first beam 803 is less than 0.8 at the first frequency range, and the envelope correlation coefficient for the first incident signal 601′ and the second incident signal 601″ in said second beam 804 is less than 0.8 at the first frequency range.

In an embodiment, said plurality of resonant gaps 637 being arranged by resonators 632, where said resonators 632 comprise electrically non-conductive regions 518 between edges of conductive members 517, and further where said dual polarized repeater 500 comprises at least two isolated connections (638, 639) to connect said first incident signal 601′ to said first beam 803 and said second incident signal 601″ to said second beam 804 for providing said at least two discriminated communication channels (630, 631) at a first frequency range, wherein in said arrangement a plurality of coupling members 522 is arranged at least partly inside said electrically non-conductive regions 518 to enhance the coupling of the received electromagnetic energy of said first polarization component 611 from the first set of resonators 633 to the second set of resonators 634 to connect said first incident signal 601′ to said first beam 803.

In an embodiment, said dual polarized repeater 500 comprises a plurality of coupling members 522, said coupling members 522 being arranged at least partly inside the electrically non-conductive regions 518 of said resonant gaps 637, where said coupling members 522 are arranged to enhance the coupling of the received electromagnetic energy of said first polarization component 611 from the first set of resonators 633 to one of said at least two isolated connections (638, 639).

In an embodiment, said dual polarized repeater 500 comprises an electrically conductive structural member 523, where said electrically conductive structural member 523 is adapted to be installed into a discontinuity region 101 of the space divider, where at least a part of the elements of said first set of resonators 633 or said second set of resonators 634 is arranged as slots or grooves in said electrically conductive structural member 523, and further, where the surface of said electrically conductive structural member 523 defines a signal propagation direction for said communication channels (630, 631) from the first side 80 of the space divider 90 to the second side 81 of the space divider 90.

In an embodiment, said first beam 803 is arranged to cover a first solid angle on the second side 81 of the space divider 90, and said second beam 804 is arranged to cover a second solid angle on the second side 81 of the space divider 90, where said first beam 803 and said second beam 804 are arranged to cover substantially separated spherical sectors on the second side 81 of the space divider 90, and where said solid angles are defined by the 3 dB beamwidths of the bistatic radar cross section pattern.

In an embodiment, said first beam 803 is arranged to cover a first solid angle on the second side 81 of the space divider 90, and said second beam 804 is arranged to cover a second solid angle on the second side 81 of the space divider 90, where said first beam 803 and said second beam 804 are arranged to cover substantially overlapping spherical sectors on the second side 81 of the space divider 90, and where said solid angles are defined by the 3 dB beamwidths of the bistatic radar cross section pattern.

In an embodiment, said at least two isolated connections are arranged at least partly by means of electric field coupling or magnetic field coupling.

In an embodiment, said at least two isolated connections comprise a waveguide, a transmission line, or a thermal break.

In an embodiment, said dual polarized repeater 500 is arranged to be coupled permanently or temporarily with an external radio transceiver or transmission line by means of any of a galvanic contact such as soldering or a contact spring, contactless electromagnetic coupling, a sticker, a magnet, a snap-on fastener, a hook-and-loop fastener or glue, or lamination.

In an embodiment, said device 501 is arranged to depolarize at least one of the signals received in said first 611 and second 612 polarization before re-radiating said signals to the second side of the space divider in two crossing polarizations of said first 613 and second 614 re-radiated polarization components.

In an embodiment, said dual polarized repeater 500 is arranged to increase the bistatic radar cross section through said discontinuity region 101 at least 3 dB in two crossing polarizations at a second frequency range, where said first frequency range is between 300 MHz and 1000 MHz, and said second frequency range is between 1400 MHz and 6000 MHz, and both said first and said second frequency ranges comprise a bandwidth of at least 100 MHz.

In an embodiment, said dual polarized repeater 500 is arranged to increase the bistatic radar cross section through said discontinuity region 101 at least 3 dB in two crossing polarizations at a third frequency range, where said third frequency range is between 20 GHz and 70 GHz, and said third frequency range comprises a bandwidth of at least 100 MHz.

In an embodiment, said group of radiators 502 is arranged to couple inductively, capacitively, or galvanically to a conductive structural member 523 of the space divider 90 in an arrangement where said conductive structural member acts as a current return path for said coupled radiators 502 at the first frequency range.

In an embodiment, said group of radiators 502 comprises a first set of resonators 633 comprising at least two dual mode resonators 632 to receive and discriminate signals of said first 611 and a second 612 incident polarization components at the first frequency range from the first side of the space divider, where said first 611 and second 612 incident polarization components are crossing polarizations, and further where said at least two dual mode resonators 632 have at least two resonant modes at the first frequency range which are arranged to receive the first incident polarization component 611 by a first resonant mode, wherein in said arrangement the reception of the first incident polarization component 611 by a second resonant mode is arranged to be suppressed, and further the dual mode resonators 632 are arranged to receive the second incident polarization component 612 by a second resonant mode, wherein in said arrangement the reception of the second incident polarization component 612 by the first resonant mode is arranged to be suppressed.

In an embodiment, said device 501 is arranged to enhance cyclic delay diversity by providing at least one delayed signal component, said at least one delayed signal component being delayed from said first incident signal 601′ or said second incident signal 601″ by a delay, where said delay is larger than 0 μs and smaller than 1.2 μs and the first frequency is less than 6 GHz, or said delay is longer than 0 μs and shorter than 0.15 μs and the first frequency is higher than 6 GHz.

In an embodiment, said device 501 comprises at least one band stop filter that is arranged to suppress the propagation of a signal component at a frequency that is different from the frequency of the first 601′ or second 601″ incident signal.

In an embodiment, said device 501 comprises at least one band stop filter that is arranged to suppress the propagation of a signal component at a frequency that is different from the frequency of the first 601′ or second 601″ incident signal, wherein said at least one band stop filter is a resonator.

In an embodiment, there is provided an entity comprising a space divider 90 and a device 501 for repeating wireless electromagnetic signals from a first side 80 of the space divider 90 to a second side 81 of the space divider 90, the device 501 being adapted to provide at least two discriminated communication channels (630,631) at a first frequency range between the two spaces separated by the space divider 90, characterized in that the device 501 comprises a dual polarized repeater 500, said repeater 500 comprising a dielectric member 303, and a set of conductive members arranged as a group of radiators 502 to form said dual polarized repeater 500, where said dual polarized repeater 500 is adapted to be installed into a discontinuity region 101 of the space divider to create said at least two discriminated communication channels (630, 631) by providing an increment of the bistatic radar cross section through said discontinuity region 101 for a first incident signal 601′ received at a first incident polarization component 611 and for a second incident signal 601″ received at a second incident polarization component 612, where at least a part of said first incident signal 601′ is scattered to a first beam 803, and at least a part of said second incident signal 601″ is scattered to a second beam 804 by said device 501, where said first 803 and said second 804 beams are arranged on the second side 81 of the space divider 90; and said dual polarized repeater 500 is adapted to provide cross polarization discrimination for said first incident signal 601′ in said first beam 803, and said dual polarized repeater 500 is adapted to provide cross polarization discrimination for said second incident signal 601″ in said second beam 804.

In an embodiment, said entity is one of a construction supply, a building, a cargo container, a reefer, a housing container, a railway carriage, an elevator shaft or an elevator car, a ship cabin, or a modular space.

In accordance with an embodiment, there is provided a method for operating a node over a wireless communication link, where said node is enclosed by a spatially isolated cell, said cell is enclosed at least partly by a space divider 90, and said wireless communication link is established from a first side 80 of the space divider 90 to a second side 81 of the space divider 90, characterized in that the method comprises; repeating wireless electromagnetic signals from the first side 80 of said space divider 90 to the second side 81 of said space divider 90 using a device 501, the device 501 providing at least two discriminated communication channels (630, 631) at a first frequency range between the two spaces separated by the space divider 90, where the device 501 comprises a dual polarized repeater 500, said dual polarized repeater 500 being installed into a discontinuity region 101 of the space divider 90; wherein the method further comprises:
receiving by said dual polarized repeater 500 a first incident signal 601′ at a first incident polarization component 611;
receiving by said dual polarized repeater 500 a second incident signal 601″ at a second incident polarization component 612;
creating by said dual polarized repeater 500 said at least two discriminated communication channels (630,631) by providing an increment of the bistatic radar cross section through said discontinuity region 101 for the first incident signal 601′ and for the second incident signal 601″,
scattering at least a part of said first incident signal 601′ by said device 501 to a first beam 803 on the second side 81 of the space divider 90, and
scattering at least a part of said second incident signal 601″ to a second beam 804 by said device 501 on the second side 81 of the space divider 90;

providing by said dual polarized repeater 500 cross polarization discrimination for said first incident signal 601′ in said first beam 803; and

providing by said dual polarized repeater 500 cross polarization discrimination for said second incident signal 601″ in said second beam 804.

In an embodiment, said method is characterized in that said node comprises a RFID tag or a wireless sensor.

In an embodiment, said method is characterized by operating a plurality of spatially divided cells comprising a node by said wireless communication link adapted for a fixed wireless access, and isolating each of said cells by an attenuation of 10-70 dB between said cells at said first frequency range.

In an embodiment, said method is characterized by providing at least one delayed signal component, where said at least one delayed signal component is delayed from said first incident signal 601′ or said second incident signal 601″ by a delay, where said delay is larger than 0 μs and smaller than 1.2 μs and the first frequency is less than 6 GHz, or said delay is larger than 0 μs and smaller than 0.15 μs and the first frequency is higher than 6 GHz.

The present disclosure is not limited solely to the above-presented embodiments, but it can be modified within the scope of the appended claims.

1. A device providing at least two discriminated communication channels for repeating wireless electromagnetic signals from a first side of a space divider to a second side of the space divider-through a sub-wavelength passage of the space divider at a first frequency range between two spaces separated by the space divider, the device comprising:
a dual polarized repeater comprising a dielectric member, and a set of conductive members arranged as a group of radiators, where;
said dual polarized repeater is configured to be installed into a discontinuity region of the space divider to create said at least two discriminated communication channels by providing an increment of a bistatic radar cross section through said discontinuity region for a first incident signal received by the device at a first incident polarization component and for a second incident signal received by the device at a second incident polarization component, where at least a part of said first incident signal is configured to be scattered as a first beam by said device on the second side of the space divider, and at least a part of said second incident signal is configured to be scattered as a second beam by said device on the second side of the space divider; and
said dual polarized repeater to provides cross polarization discrimination for said first incident signal in said first beam; and
said dual polarized repeater to provides cross polarization discrimination for said second incident signal in said second beam, wherein
said increment of the bistatic radar cross section is at least 3 dB and said cross polarization discrimination is at least 6 dB within said first beam at the first frequency range, and
said increment of the bistatic radar cross section is at least 3 dB and said cross polarization discrimination is at least 6 dB within said second beam at the first frequency range, and
said group of radiators comprises:
a first set of resonators comprising at least two dual mode resonators to receive and discriminate signals of said first and second incident polarization components at the first frequency range from the first side of the space divider, where said first and second incident polarization components are crossing polarizations, and further where said at least two dual mode resonators have at least two resonant modes at the first frequency range which are configured to receive the first incident polarization component by a first resonant mode, wherein in said arrangement the reception of the first incident polarization component by a second resonant mode is configured to be suppressed, and further the dual mode resonators are configured to receive the second incident polarization component by a second resonant mode, wherein in said arrangement the reception of the second incident polarization component by the first resonant mode is configured to be suppressed.

2. The device according to claim 1, wherein said group of radiators comprises:
a first set of resonators to receive and discriminate signals of said first and the second incident polarization components at the first frequency range from the first side of the space divider, where said first and second incident polarization components are crossing polarizations, and where said first set of resonators is configured to receive said first polarization component by a plurality of resonant gaps arranged within the set of conductive members, and
a second set of resonators is configured to form said first beam and said second beam,
wherein said first beam has a polarization according to the first re-radiated polarization component; and said second beam has a polarization according to the second re-radiated polarization component, where said first re-radiated polarization component and second re-radiated polarization component are crossing polarizations.

3. The device according to claim 2, wherein said plurality of resonant gaps have resonators comprising electrically non-conductive regions between edges of said conductive members where said non-conductive regions comprise at least a first and a second edge section, and a return path arranged between said first and said second edge sections, wherein said edge sections and said return path define a curve where said curve coils said non-conductive region and the length of said curve is at least a quarter of a wavelength at the first frequency range and said return path comprises a low impedance path or a displacement current between charge nodes, and further where:
said resonant gaps are configured to induce a positive charge distribution, and a negative charge distribution along said curve by the received electromagnetic energy of said first incident polarization component, wherein said positive and negative charge distributions are separated by a distance of larger than a quarter of a wavelength at the first frequency range along said curve, and where the shortest distance between said positive charge distribution, and said negative charge distribution is configured to be less than a quarter of a wavelength at the first frequency range, where:
said positive and said negative charge distributions are configured to generate a potential difference between said first and said second edge section within said non-conductive region, and a current loop oscillating at the first frequency range between two nodes defined by said positive and said negative charge distributions, where said oscillating current loop flows along said curve.

4. The device according to claim 2, wherein said plurality of resonant gaps have resonators comprising electrically non-conductive regions between edges of conductive members where said non-conductive regions comprise at least first and second edge sections of conductive members, and a fold of said dielectric member between said first and said second edge sections, wherein said first and second edge sections and said fold of said dielectric member define a part of a curve, where said curve coils said non-conductive region and the length of said curve is at least a quarter of a wavelength at the first frequency range and;
said resonant gaps are configured to induce a positive charge distribution, and a negative charge distribution along said curve by the received electromagnetic energy of said first incident polarization component, wherein said positive and negative charge distributions are separated by a distance of less than a quarter of a wavelength at the first frequency range, where:
said positive and said negative charge distributions are configured to generate a potential difference between said first and said second edge section within said non-conductive region, and a differential current pair oscillating along said first and said second edge sections, and further where:
said first edge sections are arranged by conductive members positioned on said dielectric member, and
said second edge sections are arranged either by conductive members positioned on said dielectric member or an electrically conductive surface of said space divider.

5. The device according to claim 1, wherein said dual polarized repeater comprises at least two isolated connections configured to connect said first incident signal to said first beam and said second incident signal to said second beam for providing said at least two discriminated communication channels at a first frequency range in an arrangement, where said at least two isolated connections are on said dielectric member, and further where the surface of said dielectric member defines a signal propagation direction for said communication channels from the first side of the space divider to the second side of the space divider.

6. The device according to claim 1, wherein said dual polarized repeater is configured to create said at least two discriminated communication channels with an arrangement of said first beam and said second beam, where
the envelope correlation coefficient for the first incident signal and the second incident signal in said first beam is less than 0.8 at the first frequency range, and
the envelope correlation coefficient for the first incident signal and the second incident signal in said second beam is less than 0.8 at the first frequency range.

7. The device according to claim 1, wherein said first beam covers a first solid angle on the second side of the space divider, and said second beam covers a second solid angle on the second side of the space divider, where said first beam and said second beam cover substantially separated spherical sectors on the second side of the space divider, and where said solid angles are defined by the 3 dB beamwidths of the bistatic radar cross section pattern.

8. The device according to claim 1, wherein said first beam covers a first solid angle on the second side of the space divider, and said second beam covers a second solid angle on the second side of the space divider, where said first beam and said second beam cover substantially overlapping spherical sectors on the second side of the space divider, and where said solid angles are defined by the 3 dB beamwidths of the bistatic radar cross section pattern.

9. The device according to claim 5, wherein said at least two isolated connections comprise a waveguide, a transmission line, or a thermal break.

10. The device according to claim 2, wherein said dual polarized repeater is configured to be coupled permanently or temporarily with an external radio transceiver or transmission line by means of any of a galvanic contact.

11-17. (canceled)

18. The device according to claim 10, wherein the galvanic contact is at least one of soldering or a contact spring, a contactless electromagnetic coupling, a sticker, a magnet, a snap-on fastener, a hook-and-loop fastener, glue, or lamination.

19. An entity comprising a space divider and a device for repeating wireless electromagnetic signals from a first side of the space divider to a second side of the space divider, the device providing at least two discriminated communication channels through a sub-wavelength passage of the space divider at a first frequency range between the two spaces separated by the space divider, the device comprising:
a dual polarized repeater comprising a dielectric member, and a set of conductive members arranged as a group of radiators, where
said dual polarized repeater is configured to be installed into a discontinuity region of the space divider to create said at least two discriminated communication channels by providing an increment of a bistatic radar cross section through said discontinuity region for a first incident signal received at a first incident polarization component and for a second incident signal received at a second incident polarization component, where at least a part of said first incident signal is scattered as a first beam on the second side of the space divider, and at least a part of said second incident signal is scattered to a second beam by said device on the second side of the space divider; and
said dual polarized repeater provides cross polarization discrimination for said first incident signal in said first beam, and
said dual polarized repeater provides cross polarization discrimination for said second incident signal in said second beam, wherein
said increment of the bistatic radar cross section is at least 3 dB and said cross polarization discrimination is at least 6 dB within said first beam at the first frequency range, and
said increment of the bistatic radar cross section is at least 3 dB and said cross polarization discrimination is at least 6 dB within said second beam at the first frequency range, and
said dual polarized repeater comprises at least two isolated connections to connect the incident signal to the first beam and the second incident signal to the second beam for providing the at least two discriminated communication channels at a first frequency range, where said isolated connections are provided by dual mode resonators, where said isolation of the connections is provided by a cross-mode suppression of the two resonant modes at the first frequency range within said dual mode resonator.

20. The entity according to claim 19, wherein the entity is one of a construction supply, a building, a cargo container, a reefer, a housing container, a railway carriage, a ship cabin, or a modular space.

21. A method for operating a node over a wireless communication link, where said node is enclosed by a spatially isolated cell, said cell is enclosed at least partly by a space divider, and said wireless communication link is established from a first side of the space divider to a second side of the space divider through a sub-wavelength passage at a first frequency range, the method comprising:
repeating wireless electromagnetic signals from the first side of said space divider to the second side of said space divider using a device establishing at least two separated MIMO and/or diversity channels from one side of a space divider to another side of the space divider by providing at least two discriminated communication channels at a first frequency range between the two spaces separated by the space divider, where the device comprises a dual polarized repeater, said dual polarized repeater being installed into a discontinuity region of the space divider;
wherein the method further comprises:
receiving by said dual polarized repeater a first incident signal at a first incident polarization component;
receiving by said dual polarized repeater a second incident signal at a second incident polarization component;
creating by said dual polarized repeater said at least two discriminated communication channels by providing an increment of a bistatic radar cross section of at least 3 dB through said discontinuity region for the first incident signal and for the second incident signal, scattering at least a part of said first incident signal by said device to a first beam on the second side of the space divider, and
scattering at least a part of said second incident signal to a second beam by said device on the second side of the space divider;
providing by said dual polarized repeater cross polarization discrimination of at least 3 dB for said first incident signal in said first beam; and
providing by said dual polarized repeater cross polarization discrimination of at least 3 dB for said second incident signal in said second beam; and further,
providing by at least two dual mode resonators of the dual polarized repeater a cross-mode suppression of two resonant modes at the first frequency range.

22. The method according to claim 21, wherein in that said node comprises a RFID tag or a wireless sensor.

23. The method according to claim 21, wherein by operating a plurality of spatially divided cells comprising a node by said wireless communication link adapted for a fixed wireless access, and isolating each of said cells by an attenuation of 10-70 dB between said cells at said first frequency range.

24. The method according to the claim 21, wherein by providing at least one delayed signal component, where said at least one delayed signal component is delayed from said first incident signal or said second incident signal by a delay, where said delay is larger than 0 μs and smaller than 1.2 us and the first frequency is less than 6 GHz, or said delay is larger than 0 μs and smaller than 0.15 us and the first frequency is higher than 6 GHz.
